(19) United States
(12) Patent Application Publication
(10) Pub. No.: US 2022/0018715 A1
(43) Pub. Date: Jan. 20, 2022

(54) SYSTEMS AND METHODS FOR MONITORING BODY TEMPERATURE

(71) Applicant: Temperature SafeNet, Inc., Washington, DC (US)

(72) Inventor: Jerrod Edward Moton, JR., Washington, DC (US)

(73) Assignee: Temperature SafeNet, Inc., Washington, DC (US)

(21) Appl. No.: 17/330,178

(22) Filed: May 25, 2021

Related U.S. Application Data
(60) Provisional application No. 63/053,136, filed on Jul. 17, 2020.

(51) Int. Cl. G01J 5/00; G01J 5/04; G01J 5/02; G06K 9/00; G07C 9/22; G01J 5/06

(52) U.S. Cl. CPC G01J 5/0025; G01J 5/047; G01J 5/0265; G01J 5/027; G06K 9/00281; G06K 9/00248; G01J 2005/068; G06K 9/00255; G01J 5/025; G07C 9/22; G01J 5/06; G01J 2005/0077; G06K 9/00604

(57) ABSTRACT

An autonomous vehicle control system includes at least one processor. The at least one processor is configured to cause a first device to monitor a body temperature of a first person, determine, responsive to the monitoring, as a first determination result, whether the monitored body temperature exceeds a predetermined threshold, perform image processing on an image of the first person, determine, based on a result of the image processing, as a second determination result, whether the first person wears a face mask, and control a second device based on at least one of the first determination result or the second determination result.

### CROSS-REFERENCE TO RELATED APPLICATION

This application claims priority to U.S. Provisional Patent Application No. 63/053,136, filed Jul. 17, 2020, which is incorporated by reference in its entirety for all purposes.

### TECHNICAL FIELD

The present disclosure relates to systems and methods for monitoring body temperature and more particularly to managing one or more thermal scanners including a mobile temperature device, and systems and methods for monitoring body temperature using one or more thermal scanners.

### BACKGROUND

Under a virus pandemic situation, like COVID-19, where there are no vaccines nor specific antiviral treatments for a virus, preventive measures such as wearing a face mask in public settings and monitoring and self-isolation for people who suspect they are infected are strongly recommended. Ongoing monitoring in a workplace can be performed by developing and implementing procedures to check for signs and symptoms of employees daily upon arrival and to encourage anyone who is sick to stay home, and to monitor employee absences. Such ongoing monitoring also can be performed at home. A virus pandemic situation has increased demand for thermal scanners or temperature scanners which can screen the skin to infer body temperature in a contactless manner. Under this situation, improvements in a system for monitoring body temperature using thermal scanners remain desired.

### SUMMARY

Implementations of the present disclosure relate to a system and a method for monitoring body temperature and more particularly to one or more thermal scanners including a mobile temperature device, and a system and a method for monitoring body temperature using one or more thermal scanners.

In some implementations of the present disclosure, a method may include monitoring, by at least one processor, a body temperature of a first person using a first device. The method may include determining, by the at least one processor responsive to the monitoring, as a first determination result, whether the monitored body temperature exceeds a predetermined threshold. The method may include performing, by the at least one processor, image processing on an image of the first person. The method may include determining, by the at least one processor based on a result of the image processing, as a second determination result, whether the first person wears a face mask. The method may include controlling, by the at least one processor, a second device based on at least one of the first determination result or the second determination result.

In some implementations of the present disclosure, a system may include at least one processor. The at least one processor may be configured to cause a first device to monitor a body temperature of a first person, determine, responsive to the monitoring, as a first determination result, whether the monitored body temperature exceeds a predetermined threshold, perform image processing on an image of the first person, determine, based on a result of the image processing, as a second determination result, whether the first person wears a face mask, and control a second device based on at least one of the first determination result or the second determination result.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a block diagram illustrating an example of a system environment for a temperature monitoring system according to some implementations.

FIG. 2 is a block diagram illustrating an example of a computing system according to some implementations.

FIG. 3A to FIG. 3C are diagrams illustrating an example of a mobile temperature scanner coupled with a mobile device according to some implementations.

FIG. 4A to FIG. 4G are diagrams illustrating an example of a temperature scanner according to some implementations.

FIG. 5A to FIG. 5C are block diagrams each illustrating an example of a temperature monitoring system and a server according to some implementations.

FIG. 6A to FIG. 6C are diagrams illustrating an example of image processing for face recognition according to some implementations.

FIG. 7A to FIG. 7C are diagrams illustrating an example of image processing for mask detection according to some implementations.

FIG. 8 is an example user interface for console according to some implementations.

FIG. 9 is an example user interface for temperature detection setting according to some implementations.

FIG. 10 is an example user interface for pass management according to some implementations.

FIG. 11 is an example user interface for displaying pass permission records according to some implementations.

FIG. 12 is an example user interface for displaying a face recognition page according to some implementations.

FIG. 13 is an example user interface for display settings on recognition effects according to some implementations.

FIG. 14 is an example user interface for displaying face information according to some implementations.

FIG. 15 is an example user interface for updating temperature measurement firmware according to some implementations.

FIG. 16 is a flowchart illustrating an example methodology for monitoring body temperature using one or more thermal scanners according to some implementations.

### DETAILED DESCRIPTION

According to certain aspects, implementations in the present disclosure relate to a system and a method for monitoring body temperature and more particularly to one or more thermal scanners including a mobile temperature device, and a system and a method for monitoring body temperature using one or more thermal scanners.

Under a virus pandemic situation, like COVID-19, where there are no vaccines nor specific antiviral treatments for a virus, workplace screening may be required to restrict individual infected with or at higher risk for serious illness from the virus from accessing workplace facilities. Workplace screenings can be implemented by asking a set of questions upon entry, performing temperature checks or visual inspection, checking whether a person wears a face covering or a face mask, or other. Such screenings may need to be performed in an efficient and contactless manner. Also, such screenings may need to be easily and efficiently integrated into workplace entry management systems (hardware or software, for example) such as systems for personnel management, pass management, or attendance management.

Face recognition techniques can be utilized to identify or classify a person for workplace screenings. However, wearing face masks may make face recognition difficult through conventional facial detection programs.

In using a plurality of thermal scanners for workplace screenings, different thermal scanners may produce different data outputs, and their different applications and hardware may store and transmit data in proprietary databases and different formats. Without an efficient and flexible scheme to access such data, it would be difficult to use a plurality of thermal scanners and manage them using an integrated management application.

To solve the above-noted problems, according to certain aspects, a middleware or monitoring system (software, hardware, etc.) is provided to interface with thermal scanners for workplace temperature monitoring of employees, visitors, or strangers. In some implementations, a temperature monitoring system may provide a dashboard or console interface to display real-time data obtained from one or more thermal scanners, providing information showing statistical data and trend data related with body temperature of people in an organization.

In some implementations, thermal scanners may include infrared thermometer, laser thermometers, non-contact thermometers or temperature guns, infrared pyrometers, thermographic cameras, infrared cameras, thermal imaging cameras, ambient temperature sensors, thermal imagers, a combination thereof or like. In some implementations, a mobile/portable device may be coupled with a thermal scanner. In some implementations, a thermal scanner may be wirelessly paired or coupled with a mobile device (e.g., smartphone) or a fixed mount on a door (e.g., a front door of a house), providing information showing statistical data and trend data related with body temperature of a person or family members at home. In some implementations, the thermal scanner may communicate with a mobile device (e.g., smartphone) using Bluetooth or Wi-Fi so that a portable temperature monitoring system can provide a result of temperature monitoring fast and accurately.

In some implementations, a mobile temperature device or a mobile device (e.g., a smartphone) coupled with the mobile temperature device may be configured to apply artificial intelligence (e.g., machine learning using neural networks) calibrated for a specific emergency situation (e.g., COVID-19) to enforce preventive measure for the specific emergency situation. In some implementations, the mobile temperature device or the mobile device coupled with the mobile temperature device may be configured to perform a combination of at least one of face recognition, temperature sensors, geospatial positioning data, proximity sensors, environmental sensors, biometric sensors, motion detection, and/or a short distance communication (e.g., RFID, near field communication (NFC) or Bluetooth, among others). Performing such combination can have advantages of mutually reinforcing the effectiveness of other key components by applying artificial intelligence calibrated for a specific emergency.

In some implementations, a workplace entry management system may identify and/or classify a person upon entry using face recognition. In some implementations, the system may perform image processing on a face image using a plurality of landmarks each of which is a map of points that surround a feature of the face, e.g., eyes, mouth, nose, etc. Masks worn by people may obscure more than half of these landmarks, making face recognition difficult through conventional facial detection programs (e.g., DLib tools). In some implementations, the system may adjust or modify the landmarks used to primarily use landmarks around the eyes and brows to detect and recognize faces. In some implementations, the system may use such adjusted or modified landmarks to determine whether a person wears a mask. In some implementations, the system may use a machine learning algorithm to detect such features of the face from the face image. In another implementation, an image processor and thermal scanner are combined in a single device.

In some implementations, in order to access different data outputs produced by different thermal scanners and stored in different databases and different formats, a workplace entry management system may connect to a server via a network. In some implementations, an application programming interface (API) may be provided in the server so that the server can connect to different databases to access different data outputs produced by different thermal scanners. In some implementations, the server may include a local database so that data stored at the local database can be accessed through the API. In some implementations, the server may include an API that can access a plurality of remote databases. In some implementations, the server may include a local database and an API that can access both the local database and a plurality of remote databases.

According to certain aspects, implementations in the present disclosure relate to a method including monitoring, by at least one processor, a body temperature of a first person using a first device. The method may include determining, by the at least one processor responsive to the monitoring, as a first determination result, whether the monitored body temperature exceeds a predetermined threshold. The method may include performing, by the at least one processor, image processing on an image of the first person. The method may include determining, by the at least one processor based on a result of the image processing, as a second determination result, whether the first person wears a face mask. The method may include controlling, by the at least one processor, a second device based on at least one of the first determination result or the second determination result.

According to certain aspects, implementations in the present disclosure relate to a system may include at least one processor. The at least one processor may be configured to cause a first device to monitor a body temperature of a first person, determine, responsive to the monitoring, as a first determination result, whether the monitored body temperature exceeds a predetermined threshold, perform image processing on an image of the first person, determine, based on a result of the image processing, as a second determination result, whether the first person wears a face mask, and control a second device based on at least one of the first determination result or the second determination result.

Various implementations in the present disclosure have one or more of the following advantages and benefits.

First, implementations in the present disclosure can perform a combination of at least one of face recognition, temperature sensors, motion detection, and/or a short distance communication (e.g., near field communication (NFC) or Bluetooth, among others). Performing such combination can have advantages of mutually reinforcing the effectiveness of other key components by applying artificial intelligence calibrated for a specific emergency.

Second, implementations in the present disclosure can display real-time data obtained from a thermal scanner, providing real-time related with body temperature of people in an organization, and control a physical device (e.g., gate) using the real-time data. With this configuration, the organization can efficiently and effectively restrict individual infected with or at higher risk for serious illness from the virus from accessing workplace facilities in an automated and contactless manner.

Third, implementations in the present disclosure can perform image processing to determine whether a person wears a face mask or to recognize the face of a person by adjusting or modifying landmarks of the face. This configuration can provide a more stable way of face recognition even when a person wears a face mask or a face covering.

Fourth, implementations in the present disclosure can provide an application programming interface (API) in a server so that workplace entry management system coupled with a plurality of different thermal scanners can connect to different databases to access different data outputs produced by different thermal scanners. This configuration can provide an efficient and flexible scheme to access different data outputs that are produced by different thermal scanners and stored in different databases and different formats.

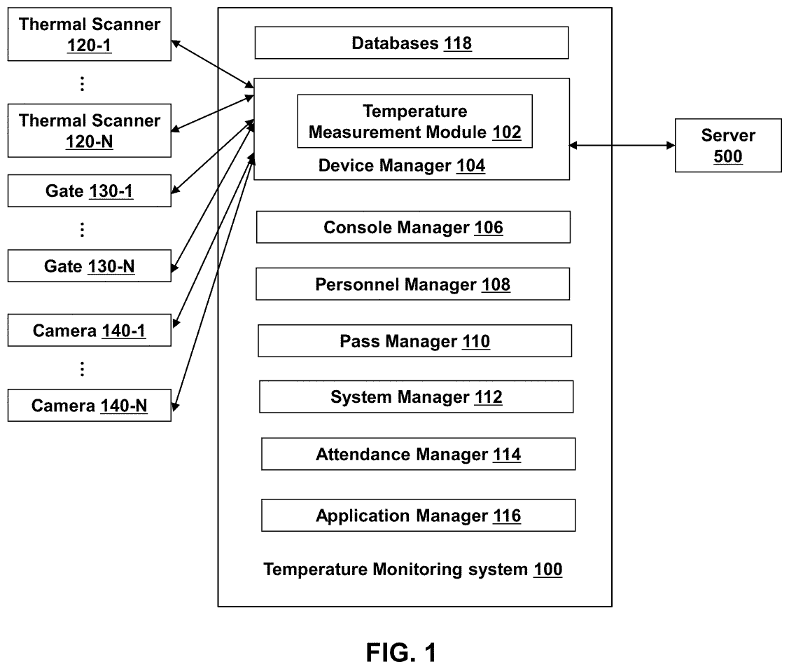

FIG. 1 is a block diagram illustrating an example of a system environment for a temperature monitoring system according to some implementations.

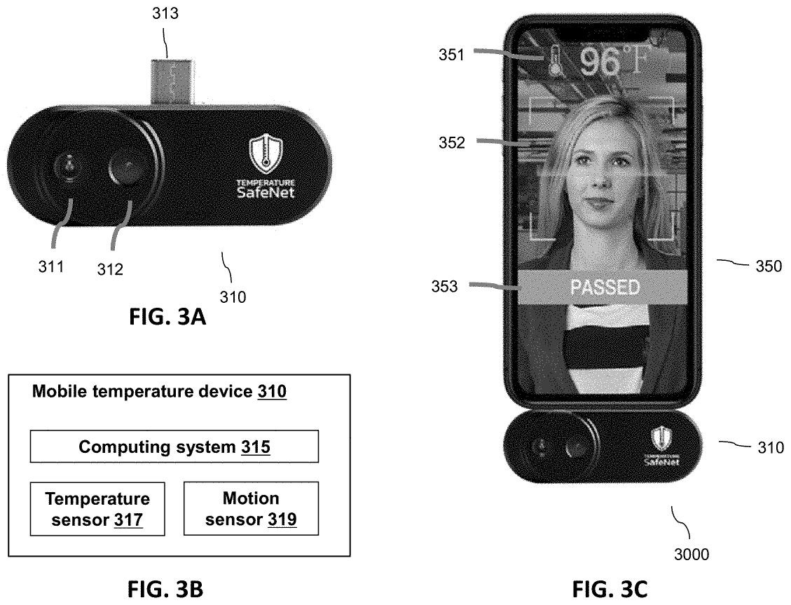

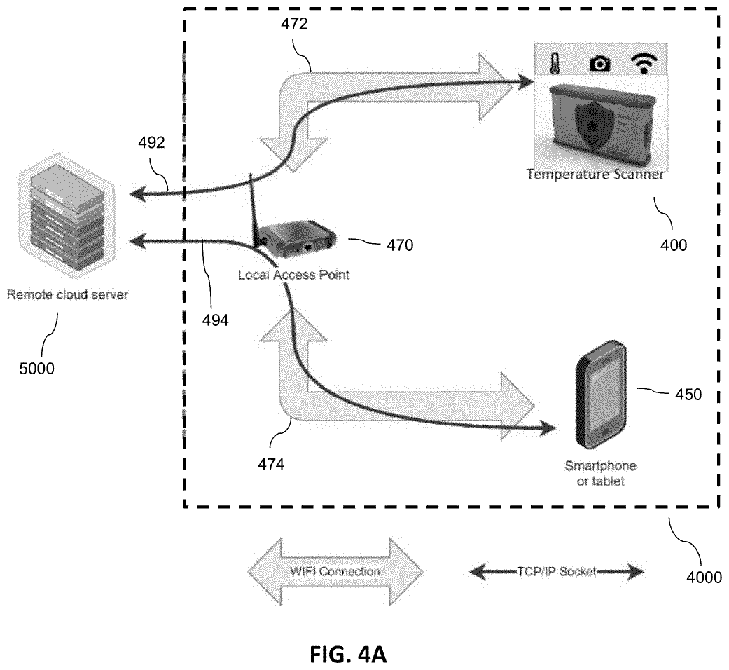

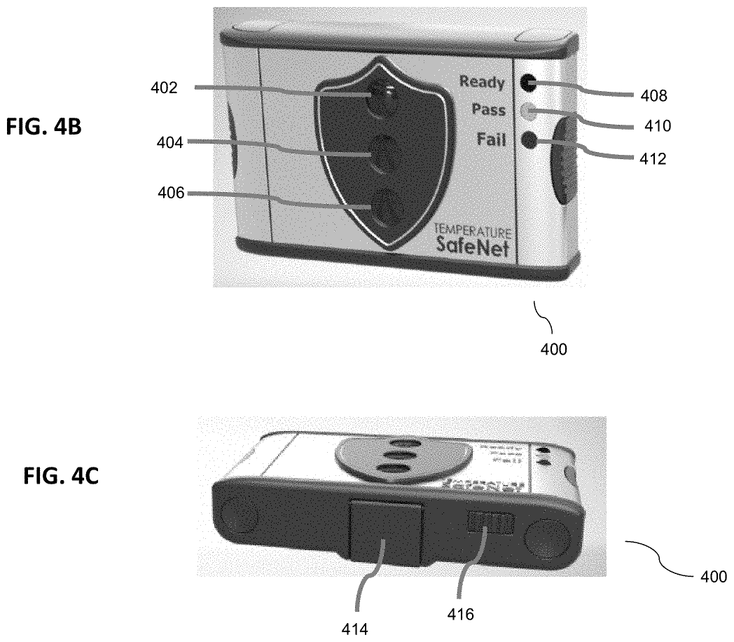

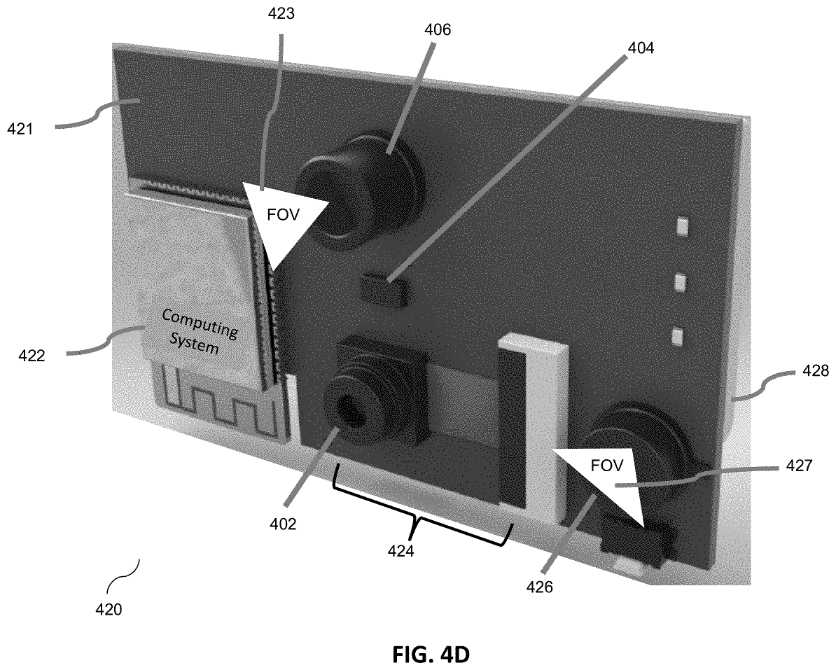

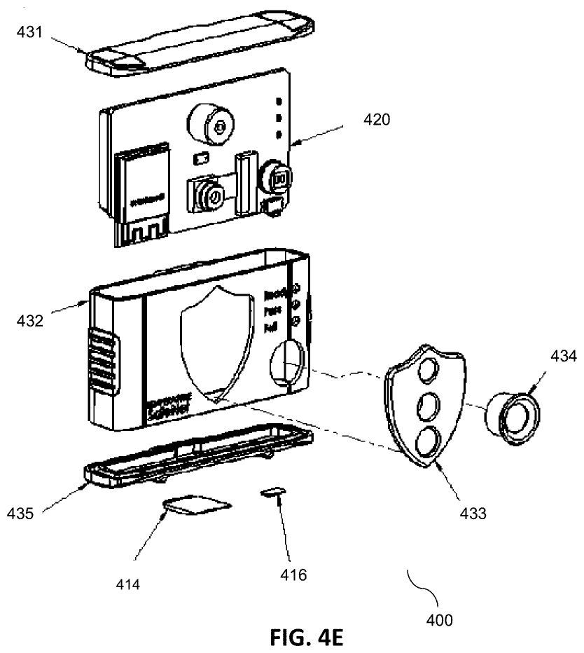

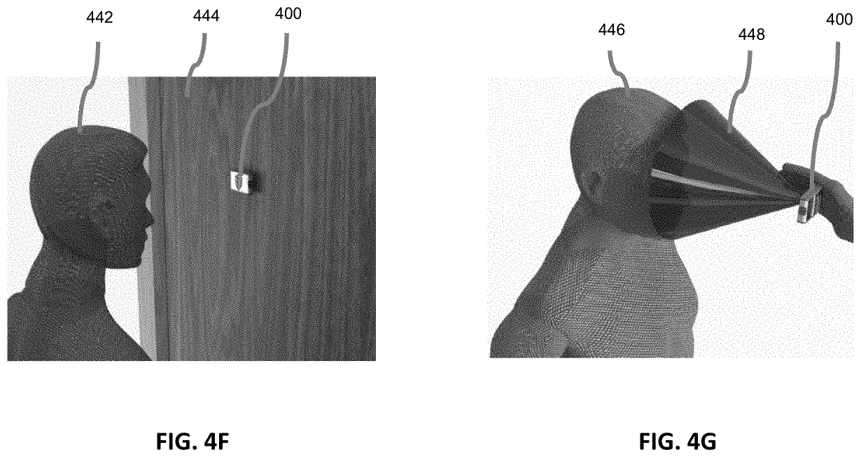

Referring to FIG. 1, a system 100 may be a temperature monitoring system or a workplace entry management system. The system 100 may be coupled or paired with one or more thermal scanners 120-1 to 120-N. In some implementations, the system 100 may be connected to one or more thermal scanners 120-1 to 120-N via a network. In some implementations, the thermal scanners may include infrared thermometer, laser thermometers, non-contact thermometers or temperature guns, infrared pyrometers, thermographic cameras, infrared cameras, thermal imaging cameras, thermal imagers, a combination thereof or like. In some implementations, the thermal scanners may include a mobile temperature device 310 as shown in FIG. 3A or a temperature scanner 400 as shown in FIG. 4A to FIG. 4G.

In some implementations, the system 100 may be coupled or paired with one or more gates 130-1 to 130-N. In some implementations, the system 100 may be connected to one or more gates 130-1 to 130-N via a network. In some implementations, the system 100 may be coupled or paired with one or more cameras 140-1 to 140-N. In some implementations, the system 100 may be connected to one or more cameras 140-1 to 140-N via a network. In some implementations, the system 100 may be connected to a server 500 via a network. Here, the network may be a Local Area Network (“LAN”), a wide area network (“WAN”), a wireless network, and/or the Internet, among others. The wireless network may be the IEEE 802.11 protocols, near field communication (NFC), Bluetooth, ANT, or any other wireless protocol, among others.

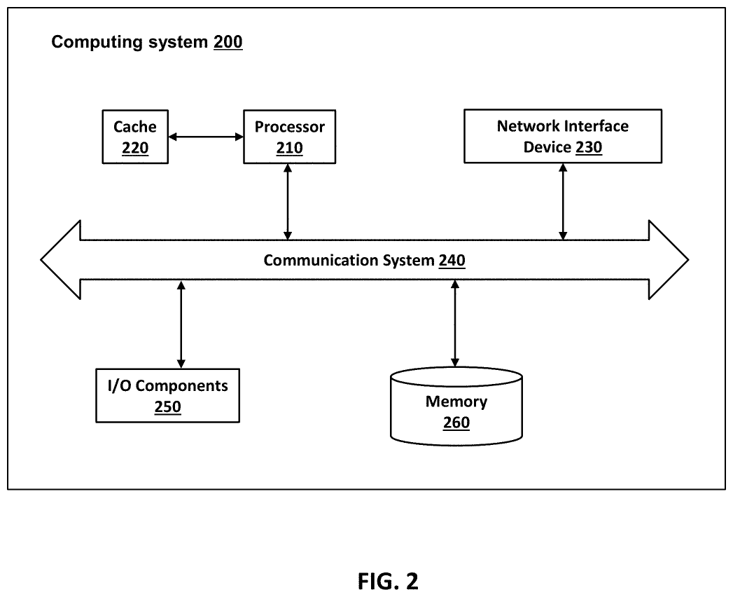

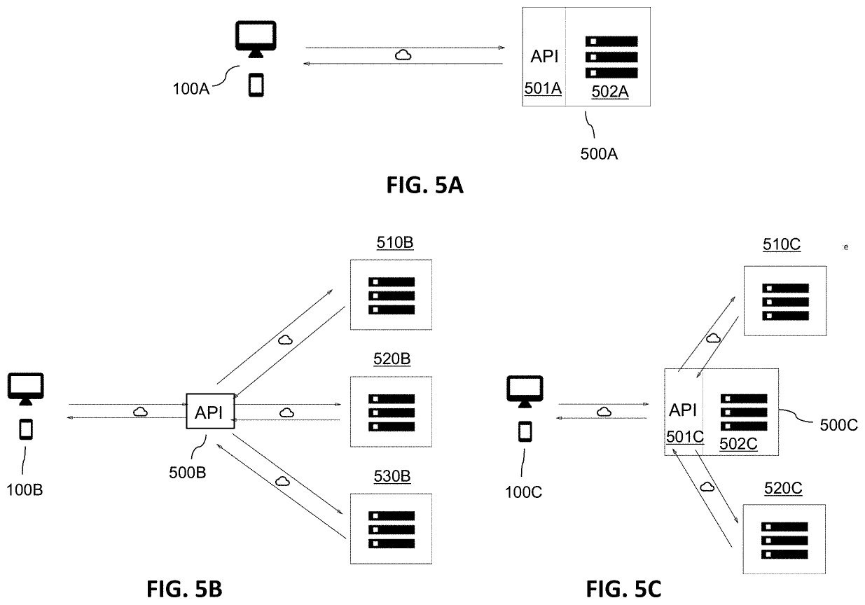

In some implementations, the system 100 may include one or more of a console manager 106, a device manager 104, a personnel manager 108, a pass manager 110, a system manager 112, an attendance manager 114, or an application manager 116, which perform console management, device management, personnel management, pass management, system management, attendance management, or application management, respectively, which will be described below with reference to FIG. 5A to FIG. 15. In some embodiments, at least one or more of the a console manager 106, device manager 104, personnel manager 108, pass manager 110, system manager 112, attendance manager 114, or application manager 116 may be implemented with a circuit (e.g., circuitry of a FPGA, CPU, GPU or other processing circuits implemented using electronic circuits), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like. In some implementations, the device manager 104 may include a temperature measurement module 102 which controls one or more of the thermal scanners 120-1 to 120-N to measure body temperature and output body temperature data. In some implementations, the system 100 may include one or more databases 118 to store data managed by one or more of the console manager 106, device manager 104, personnel manager 108, pass manager 110, system manager 112, attendance manager 114, or application manager 116 (e.g., device data, personnel data, pass records, system logs, attendance records, or application data, or photos of employees or visitors, etc.). Each of the system 100 and the server 500 may have configurations similar to those of computing system 200 in FIG. 2.

FIG. 2 is a block diagram illustrating an example of a computing system according to some implementations.

Referring to FIG. 2, the illustrated example computing system 172 includes one or more processors 210 in communication, via a communication system 240 (e.g., bus), with memory 260, at least one network interface controller 230 with network interface port for connection to a network (not shown), and other components, e.g., an input/output (“I/O”) components interface 450 connecting to a display (not illustrated) and an input device (not illustrated). Generally, the processor(s) 210 will execute instructions (or computer programs) received from memory. The processor(s) 210 illustrated incorporate, or are directly connected to, cache memory 220. In some instances, instructions are read from memory 260 into the cache memory 220 and executed by the processor(s) 210 from the cache memory 220.

In more detail, the processor(s) 210 may be any logic circuitry that processes instructions, e.g., instructions fetched from the memory 260 or cache 220. In some implementations, the processor(s) 210 are microprocessor units or special purpose processors. The computing device 200 may be based on any processor, or set of processors, capable of operating as described herein. The processor(s) 210 may be single core or multi-core processor(s). The processor(s) 210 may be multiple distinct processors.

The memory 260 may be any device suitable for storing computer readable data. The memory 260 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 172 may have any number of memory devices as the memory 260.

The cache memory 220 is generally a form of computer memory placed in close proximity to the processor(s) 210 for fast read times. In some implementations, the cache memory 220 is part of, or on the same chip as, the processor(s) 210. In some implementations, there are multiple levels of cache 220, e.g., L2 and L3 cache layers.

The network interface controller 230 manages data exchanges via the network interface (sometimes referred to as network interface ports). The network interface controller 230 handles the physical and data link layers of the OSI model for network communication. In some implementations, some of the network interface controller's tasks are handled by one or more of the processor(s) 210. In some implementations, the network interface controller 230 is part of a processor 210. In some implementations, a computing system 172 has multiple network interfaces controlled by a single controller 230. In some implementations, a computing system 172 has multiple network interface controllers 230. In some implementations, each network interface is a connection point for a physical network link (e.g., a cat-5 Ethernet link). In some implementations, the network interface controller 230 supports wireless network connections and an interface port is a wireless (e.g., radio) receiver/transmitter (e.g., for any of the IEEE 802.11 protocols, near field communication “NFC”, Bluetooth, ANT, or any other wireless protocol). In some implementations, the network interface controller 230 implements one or more network protocols such as Ethernet. Generally, a computing device 172 exchanges data with other computing devices via physical or wireless links through a network interface. The network interface may link directly to another device or to another device via an intermediary device, e.g., a network device such as a hub, a bridge, a switch, or a router, connecting the computing device 172 to a data network such as the Internet.

The computing system 172 may include, or provide interfaces for, one or more input or output (“I/O”) devices 250. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 172 may include an interface (e.g., a universal serial bus (USB) interface) for connecting input devices, output devices, or additional memory devices (e.g., portable flash drive or external media drive). In some implementations, a computing device 172 includes an additional device such as a co-processor, e.g., a math co-processor can assist the processor 210 with high precision or complex calculations.

FIG. 3A to FIG. 3C are diagrams illustrating an example of a mobile temperature device coupled with a mobile device according to some implementations.

FIG. 3A illustrates an external appearance of a mobile temperature device 310 according to some implementations. The mobile temperature device 310 may include one or more infrared light lenses or infrared lenses 311, one or more visible light lenses 312, and a connector 313. The connector 313 may be a connector that can be connected to a computing system having configuration similar to the computing system 200 (e.g., a mobile device 350 in FIG. 3B). For example, the connector 313 may be a universal serial bus (USB) connector, a lightning connector, a micro USB connector, or the like.

FIG. 3B illustrates a block diagram illustrating an example of configuration of the mobile temperature device 310 according to some implementations. The mobile temperature device 310 may include a computing system 315 which has configuration similar to that of the computing system 200. The mobile temperature device 310 may include one or more temperature sensors 317 and/or one or more motion sensors 319. The one or more temperature sensors 317 may be an infrared sensor or any other thermal sensor. The one or more motion sensors 319 may be an infrared sensor, a proximity sensor, a combination thereof, or the like.

A specification of the mobile temperature device 310 is shown in Table 1 as an example. That is, the present disclosure is not limited to the specification shown in Table 1.

TABLE 1

| Infrared thermal | temperature detection | YES |
|---|---|---|
| imaging module | Temperature | 1 meter (≤0.5 meter) |
| | detection distance | |
| | Temperature | ≤ ± 0.2° C. |
| | measurement accuracy | |
| | Temperature | 10° C. ~ 42° C. |
| | measurement range | |
| | Thermal Field of View | 32 × 32° C. |
| | Normal temperature | YES |
| | release | |
| | Over temperature alarm | YES |
| General parameters | Protection class | IP65, outdoor dustproof & |
| | | waterproof function |
| | Power supply | DC12V (±10%) |
| | Operating temperature | 0° C. ~ 60° C. |
| | Storage temperature | −20° C. ~ 60° C. |
| | Power consumption | 13.5W (Max) |
| | Installation method | Gate brackets |
| | Equipment size | 238.24 * 128 * 21.48 (mm) |
| Camera | Pixel | 200 w pixels |
| | Type | RGB, Infrared dual camera |
| | Aperture | f/2.4 |
| | Focal Distance | 50-150 cm |
| | white balance | automatic |
| | Fill Light | LED & Infrared double fill |
| | light | |
| | Android system | 10 |

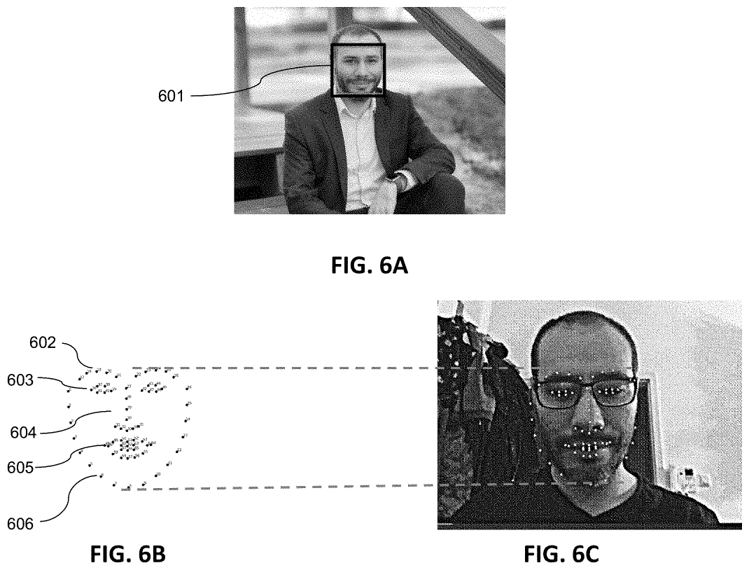

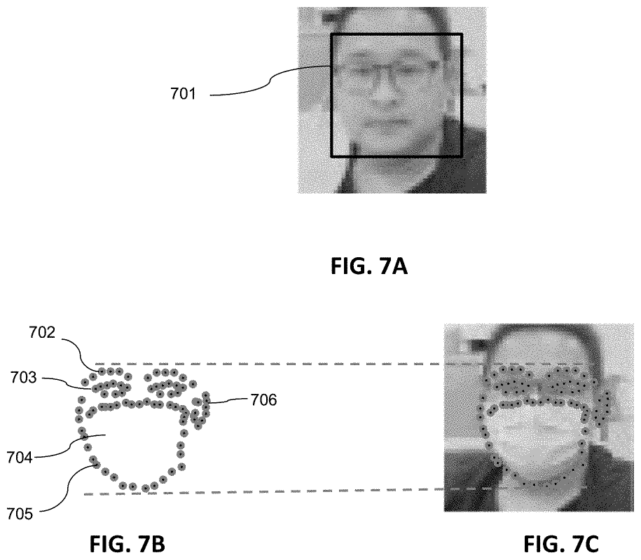

FIG. 3C shows a temperature monitoring system 3000 in which the mobile temperature device 310 is paired or coupled with a mobile device 350. The mobile device 350 may have configuration similar to that of the computing system 200. In some implementations, the temperature monitoring system 3000 may have hardware or software configurations similar to those of the temperature monitoring system 100 in FIG. 1. For example, the temperature monitoring system 3000 may configured to monitor a body temperature of a person using temperature sensor 317 and display the temperature in the form of image or text 351. The temperature monitoring system 3000 may be configured to perform face recognition via image processing on an image of the person 352 (e.g., in a manner similar to that illustrated in FIG. 6A to FIG. 6C). The temperature monitoring system 3000 may be configured to detect or recognize whether the person wears a face mask/covering via image processing on the image of the person 352 (e.g., in a manner similar to that illustrated in FIG. 7A to FIG. 7C). The temperature monitoring system 3000 may be configured to determine whether entry of a person is permitted, based on at least one of results of temperature measurement, results of face recognition, results of mask recognition. If it is determined that entry of a person is permitted, the temperature monitoring system 3000 may display a pass permission message 353 or output a sound or voice message.

FIG. 4A to FIG. 4G are diagrams illustrating an example of a temperature scanner according to some implementations.

FIG. 4A illustrates an example of a system environment for a temperature scanner 400 and a temperature monitoring system 4000 according to some implementations. In the temperature monitoring system 4000, the temperature scanner 400 is connected with a mobile device 450 via a network. For example, the temperature scanner 400 and the mobile device 450 may communicate with each other via Bluetooth or via Wi-Fi connection 472, 474 through a local access point 470). The mobile device 450 may have configuration similar to that of the computing system 200, for example, a smartphone or a tablet computer. In some implementations, the temperature monitoring system 4000 may have hardware or software configurations similar to those of the temperature monitoring system 100 in FIG. 1. For example, the temperature monitoring system 4000 may configured to monitor a body temperature of a person using a temperature sensor of the temperature scanner 400 and display the temperature in the form of image or text on the mobile device 450. The temperature monitoring system 4000 may be configured to perform face recognition via image processing on an image of a person (e.g., in a manner similar to that illustrated in FIG. 6A to FIG. 6C). The temperature monitoring system 4000 may be configured to detect or recognize whether the person wears a face mask/covering via image processing on the image of the person (e.g., in a manner similar to that illustrated in FIG. 7A to FIG. 7C). The temperature monitoring system 4000 may be configured to determine whether entry of a person is permitted, based on at least one of results of temperature measurement, results of face recognition, results of mask recognition. If it is determined that entry of a person is permitted, the temperature monitoring system 4000 may display a pass permission message or output a sound or voice message on the mobile device 450. In some implementations, the temperature monitoring system 4000 may be connected to a server 5000. The server 5000 may have configuration similar to that of the server 500 (see FIG. 1), for example, a remote cloud server.

FIG. 4B and FIG. 4C illustrate an external appearance of a temperature scanner 400 according to some implementations. The temperature scanner 400 may have a camera 402 (top lens), a distance sensor 404 (middle lens), a temperature sensor 406 (bottom lens) and a battery door 414 (a battery charger, e.g., Universal Serial Bus (USB) battery charger, is located behind the door), a power button or switch 416, a ready light 408, a pass light 410, and a fail light 412. In some implementations, the temperature scanner 400 may include a presence sensor (e.g., presence sensor 427 in FIG. 4D). The arrangement of the camera, the distance sensor and the temperature sensor is not limited to that shown in FIG. 4B. For example, a camera, a distance sensor and a temperature sensor may be located at top lens, bottom lens, and middle lens, respectively. In some implementations, the temperature scanner 400 may have one or more cameras, one or more distance sensors, and/or one or more temperature sensors. The ready light 408 (e.g., solid blue light) may be a light emitting diode (LED) light indicating that the scanner 400 or the system 4000 is ready for temperature scanning and that the subject (e.g., person) is in a correct position and is in a scan range. In some implementations, the ready light may be blinking when the subject is not in a correct position or in a scan range. The pass light 410 (e.g., solid green light) may be an LED light indicating or signifying that the subject passed a temperature test. The fail light 412 (e.g., solid red light) may be an LED light indicating or signifying that the subject failed a temperature test. In some implementations, the fail light 412 may be blinking red when the system requires a retest. In some implementations, the power button 416 may be pressed once for power on and may be pressed and hold for power off.

FIG. 4D illustrates an example of configuration of a printed circuit board (PCB) assembly 420 according to some implementations. The PCB assembly 420 may include a PCB 421 on a front side of which a computing system 422, one or more distance sensors 404, one or more temperature sensors 406, a camera assembly 424 (including one or more cameras 402), and/or one or more presence sensors 426 are mounted. On a back side of the PCB 421, one or more batteries 428 may be mounted.

In some implementations, the computing system 423 may have configurations similar to those of the computing system 200 (see FIG. 2). For example, the computing system 423 may include a Wi-Fi module and/or a Bluetooth module.

In some implementations, a camera 402 may be configured to capture video and static images with Super Video Graphics Array (SVGA) 1280/720 HD resolution. The camera 402 or the camera assembly may be configured to perform network communication (e.g., Wi-Fi connectivity), and perform a facial recognition (see FIG. 6A-FIG. 6C and FIG. 7A-FIG. 7C). For example, an image sensor (e.g., OV2640, 2MP CMOS sensor with Lens) may be used as the camera 402.

In some implementations, a distance sensor 404 may be a distance sensor or a time-of-flight sensor for providing accurate distance measurements to the subject. The distance sensor can improve the accuracy of temperature measurement because more accurate temperature readings are obtained as the subject approaches the scanner. For example, STMicroelectronics VL53L3CX time-of-flight proximity sensor may be used as the distance sensor 404.

In some implementations, a temperature sensor 406 may have at least 35° of field of view (FOV) 423 (see FIG. 4D). For example, a digital infrared temperature sensor (e.g., Melexis MLX90614ESF-BCC-000-TU) may be used as the temperature sensor 406. Table 2 shows temperature measurement results with distance varied, and Table 3 shows temperature measurement results with a static distance (9 inches). Table 2 and Table 3 show that while the temperature accuracy varied inversely with distance, when the distance was maintained, the temperature values were accurate and stable.

TABLE 2
Forehead Measurement (varied distances)

| | |
|---|---|
| Ref Temperature (° F.) | 98.6 |
| Ambient Temperature (° F.) | 71.1 |
| Distance (inches) | Reading (° F.) |
| 0 | 93.9 |
| 1 | 93.5 |
| 2 | 93.1 |
| 3 | 93 |
| 4 | 92.6 |
| 5 | 91.7 |
| 6 | 90.1 |
| 7 | 89.4 |
| 8 | 85.7 |
| 9 | 84.3 |
| 10 | 83.2 |
| 11 | 81.8 |
| 12 | 80.1 |
| 14 | 79.1 |
| 16 | 78.6 |

TABLE 3
Forehead Measurement (9 inches distance)
Reading (° F.)
83.8
82.9
83.2
83.6
83.3
82.9
83.2
83.5
83.1
82.8

In some implementations, the temperature sensor 406 can support (1) an outdoor temperature range of 60-80 degree (° F.); (2) splash proof or submersible for liquid ingress protection; (3) a sustain drop height of 5 ft; (4) system weight less than or equal to 3 Oz; and/or (5) dimension (L×W×H) of less than or equal to 1.67″×2.8″×0.75″.

In some implementations, a presence sensor 426 may be a presence sensor or a proximity sensor or an occupancy sensor. In some implementations, the presence sensor may have at least 100° FOV (FOV 427 in FIG. 4D). The presence sensor 426 may be configured to activate the thermal scanner by turning on power to key items upon approach from a subject (e.g., person). The presence sensor can operate in conjunction with the distance sensor to improve the battery life and temperature accuracy. For example, a pyroelectric motion detection sensor (e.g., Excelitas PYD1788, Digital Output Dual Element Pyro Motion Sensor) may be used as the presence sensor 426.

In some implementations, a battery 428 may be a 650 mAh battery or a 1200 mAh battery for an extended battery life. For example, a 650 mAh battery with dimension (L×W×H) of 0.9″×1.9″×0.24″ or a 1200 mAh battery with dimension (L×W×H) of 1.3″×2.4″×0.2″ or 1.1″×2.4″×0.24″ may be used as the battery 428.

FIG. 4E illustrates an exploded view of a temperature scanner 400 according to some implementations. In some implementations, a top cover 431, a main housing 432, a bottom cover 435, the battery door 414, the power button 416, a front shield 433, and the PCB assembly 420 (see FIG. 4D) may be assembled into the temperature scanner 400. In some implementations, if the temperature scanner 400 includes a presence sensor (e.g., presence sensor 426 in FIG. 4D), it includes a presence sensor cap 434. With this configuration, a user can set up a temperature scanner 400 and a temperature monitoring system 4000 as follows. For example, the user first can download an application or app to a mobile device 450 or other computing devices similar to the computing device 200. The user then can turn on a temperature scanner 400 by pressing the power button (e.g., power button 416) once. If the scanner includes a presence sensor (e.g., presence sensor 426), the user can wake up the scanner by waving hand in front of the scanner so that the presence sensor turns on the power of the scanner. In some implementations, the user can wake up the scanner by moving a Bluetooth device (e.g., mobile device 450 in FIG. 4A) close to the scanner so that the Bluetooth module of the scanner turns on the power of the scanner. The user then can configure Wi-Fi and other settings of the scanner using the app running on the mobile device so that the scanner can connect to Wi-Fi and be ready to use and the temperature monitoring system 4000 can also be ready to use.

FIG. 4F and FIG. 4G illustrate example configurations of using a temperature scanner 400 according to some implementations. In some configurations, as shown in FIG. 4F, a temperature scanner 400 is mounted on a door or wall 444 so that a proximity sensor or a distance sensor of the scanner 400 can detect a subject or a person 442 at door. In some implementations, the scanner 400 can detect the person in a distance of 6-12 inches. A user of the scanner 400 (or temperature monitoring system 4000) who may be different from the person 442, can be notified of the detection activity via an app running on a mobile device 450. The notification can be sent to the mobile device via Bluetooth if within range but otherwise through Wi-Fi or an internet connection. Next, temperature data and/or a photo of the person 442 can be sent to a server 5000 or a mobile device 450 (see FIG. 4A) via Wi-Fi or Bluetooth. In some implementations, temperature data and/or a photo of the person 442 can be stored on the server. In some implementations, temperature data and/or a photo of the person 442 can be loaded or stored into a memory of the scanner 400. For example, temperature data and/or a photo can be saved into a memory stick. Based on the temperature data and/or the photo, the user of the scanner 400 (or temperature monitoring system 4000) can decide if the subject 442 is safe via lights on the scanner (e.g., pass light 410 or fail light 412 in FIG. 4B) or the app running on the mobile device 450.

In some configurations in which the scanner 400 is mounted on the door 444 (see FIG. 4F), a subject may be provided an instruction on use. When the subject approaches the scanner on the door, a proximity sensor or a presence sensor can detect presence of the subject and wake the scanner. In some implementations, when the subject moves to the scanner in an appropriate distance for temp reading, a distance sensor of the scanner may activate a light on the scanner (e.g., ready light 408) to help guide the subject to the right distance (e.g., 6-10 inches from the scanner). For example, the ready light may be blinking when the subject is not in a correct position or in a scan range, and the ready light may be solid blue light when the subject is in a correct position and is in a scan range. In some implementations, the distance sensor can cause the scanner to process the temperature measurement only if the subject is within a correct scan range. The subject may be notified for “Pass” with a pass light (e.g., solid green light on the pass light 410 in FIG. 4B) or notified for “Fail” with a fail light (e.g., solid red light on the fail light 412 in FIG. 4B). In some implementations, the subject may be notified for “Retest” with a blinking light the fail light.

In some configurations, as shown in FIG. 4G, a temperature scanner 400 is used as a handheld device so that a user (of the scanner 400 and the system 5000) can hold the scanner and measure a temperature of a subject or a person 445 in a scan range 448. For example, to set up this configuration, the user can turn on the scanner by pressing a power button (e.g., power button 416 in FIG. 4C) once. The user can wake up the scanner via hand's movement in front of the scanner or via Bluetooth as described above with reference to FIG. 4F. The user can hold the scanner (at an appropriate distance, for example, 6-12 inches) towards the subject's head to take a temperature reading. Next, similar to the configuration illustrated in FIG. 4F, temperature data and/or a photo of the person 446 can be sent to the server 5000 or the mobile device 450 (see FIG. 4A) via Wi-Fi or Bluetooth. In some implementations, temperature data and/or a photo of the person 446 can be stored on the server or in a memory of the scanner 400. Based on the temperature data and/or the photo, the user can decide if the subject 446 is safe via lights on the scanner or the app running on the mobile device 450.

In some configurations in which the user holds the scanner 400 (see FIG. 4G), a distance sensor of the scanner may activate a light on the scanner (e.g., ready light 408) to help guide the user to place the scanner in the right distance (e.g., 6-10 inches from the scanner) from the subject 446. For example, the ready light may be blinking when the subject is not in a correct position or in a scan range, and the ready light may be solid blue light when the subject is in a correct position and is in a scan range. In some implementations, the distance sensor can cause the scanner to process the temperature measurement only if the subject is within a correct scan range. The user and the subject may be notified for “Pass” with a pass light (e.g., solid green light on the pass light 410 in FIG. 4B) or notified for “Fail” with a fail light (e.g., solid red light on the fail light 412 in FIG. 4B). In some implementations, the user and the subject may be notified for “Retest” with a blinking light the fail light.

In some implementations, one or more thermal scanners or a temperature monitoring system may be configured to apply artificial intelligence (e.g., machine learning using neural networks) calibrated for a specific emergency situation (e.g., COVID-19) to enforce preventive measure for the specific emergency situation. For example, a thermal scanner may be a thermal scanner 120-1, . . . , or 120-N (see FIG. 1), a mobile temperature device 310 (see FIG. 3A to FIG. 3C), or a temperature scanner 400 (see FIG. 4A to FIG. 4G). A temperature monitoring system may be configured as a temperature monitoring system 100 (see FIG. 1), a temperature monitoring system 3000 (see FIG. 3C), or a temperature monitoring system 4000 (see FIG. 4A). In some implementations, a thermal scanner or a temperature monitoring system may be configured to perform a combination of at least one of face recognition, temperature sensors, motion detection, and/or a short distance communication (e.g., near field communication (NFC) or Bluetooth, among others). Performing such combination can have advantages of mutually reinforcing the effectiveness of other key components by applying artificial intelligence calibrated for a specific emergency. For example, one or more thermal scanners or a temperature monitoring system may use face landmark detection (see FIG. 6B and FIG. 7B, for example), image registration (e.g., transforming different sets of face images into one coordinate system), and general feature tracking (e.g., tracking facial features corresponding to facial landmarks). One or more thermal scanners or a temperature monitoring system may detect and track a person's face in real time from the visible camera (e.g., the camera using the visible light lens 312) in real time. In some implementations, one or more thermal scanners or a temperature monitoring system can detect up to 19 facial landmarks, store facial data for both offline access and live analysis (e.g., storing facial data in databases 118 in FIG. 1), and integrate the facial data with contacts data stored in the one or more thermal scanners or the temperature monitoring system. In some implementations, one or more thermal scanners or a temperature monitoring system may perform face recognition or mask detection by adjusting the facial landmarks. More details about face recognition and mask detection will be described below with reference to FIG. 6A to FIG. 7C.

In some implementations, one or more thermal scanners or a temperature monitoring system may estimate the age of a person based on normal body temperature (see Table 2 below) since normal body temperature range is different for various age groups. In some implementations, one or more thermal scanners or a temperature monitoring system may perform face recognition combined with age estimation so as to provide fever thresholds more personalized. For example, when the scanner or system detects a person's age as falling in 3-10 years based on his or her normal temperature, the scanner or system may determine a fever threshold of 37.8° C. (according to Table 1, for example) to be higher than fever thresholds for older people.

TABLE 2

| Age | ° C. | ° F. |
|---|---|---|
| 0-2 years | 36.4-38.0 | 97.5-100.4 |
| 3-10 years | 36.1-37.8 | 97.0-100.0 |
| 11-65 years | 35.9-37.6 | 96.6-99.7 |
| >65 years | 35.8-37.5 | 96.4-99.5 |

In some implementations, one or more thermal scanners or a temperature monitoring system can improve accuracy and detection of abnormal temperatures while minimizing false positives, which feature is critical in settings with young children or seniors. In some implementations, the scanner or system can use a result of age estimation to improve face recognition even for mask-wearers using a generative adversarial network (GAN) model, for example. Thus, accurate detection of personalized abnormal temperatures is significant for other purposes, e.g., accurate face recognition.

In some implementations, one or more thermal scanners or a temperature monitoring system can utilize features of ears for face recognition because ears are an effective biometric trait. Ear images have been utilized in many different works for the purpose of person identification, age estimation, and gender classification. In some implementations, one or more thermal scanners or a temperature monitoring system may use multiple visible light cameras (e.g., using multiple visible light lenses 312) for depth and facial detection. Without this configuration, the scanner or the system can detect an object of interest more accurately in the view, particularly if a field of view is crowded (for instance, in urban environments, in a line, a crowded lobby). In some implementations, the scanner or the system can perform multi-object recognition and track multiple objects even through low-frame rates recordings.

In some implementations, one or more thermal scanners or a temperature monitoring system can produce high-resolution images which enable high accuracy. For example, the scanner or the system may include a visible light camera that has configuration of at least one or more of (1) a resolution of 3840×2160 pixels, (2) a focal length of 40 mm, (3) field of view is 100°, or (4) wide and normal visible light cameras have f/1.2 and f/2.2 aperture. In some implementations, the visible light lens 312 may have 5-6 elements and may be coated to be scratch-resistant.

In some implementations, one or more thermal scanners may use one or more edge AI chips to perform data collection and analysis within the scanner itself. In some implementations, only categorically defined data points and metadata are transferred via Wi-Fi and Bluetooth, for example, thereby reducing latency and improving battery life. The scanner's use of edge AI chips, combined with a plurality of sensors (e.g., temperature sensors and motion sensors) built in the scanner, can provide intelligent monitoring, privacy and peace of mind to the users.

In some implementations, one or more thermal scanners may automatically detect a face of a person, find the most reliable spot to measure, and send temperature readings to a computer or mobile device (e.g., mobile device 350 in FIG. 3C or mobile device 450 in FIG. 4A). Conventional handheld wireless thermometers must be held within a certain distance of the face and the user introduces variability by pointing the thermometer on the subject inconsistently. Conventional thermal scanners (e.g., IR sensors) need a black body object to calibrate and are designed to measure industrial temperatures, which are unsuited for health and personal use. One or more thermal scanners may be configured to measure body temperatures in an automated and contactless manner, thereby effectively monitoring or restricting individuals infected with or at higher risk for serious illness from the virus.

In some implementations, one or more thermal scanners may include one or more temperature sensors (e.g., one or more temperature sensors 317 in FIG. 3B or one or more temperature sensors 422 in FIG. 4D). The one or more temperature sensors may be a high quality sensor (e.g., infrared sensor) that operates with an optical camera (e.g., a camera using the visible light lens 312) so that the one or more thermal scanners or a temperature monitoring system can control the temperature sensor and the camera to display a body temperature of a particular body portion of a person (e.g., displaying a temperature 351 of the face of the person 352 in FIG. 3C).

In some implementations, one or more thermal scanners may calibrate hardware of a temperature sensor (e.g., temperature sensor 317 in FIG. 3B or temperature sensor 422 in FIG. 4D) to measure temperature ranges within a narrow range of normal temperatures and temperatures indicating fever. The temperature sensor may have configuration of at least one or more of (1) a field of view of 35° (h)/26° (v), (2) a minimal resolution of 206 (h)×156 (v), or (3) the accuracy of the temperature sensor may be ±0.3° C. (0.5° F.) between 36° C. to 40° C. (96° F. to 104° F.). With this configuration, the temperature sensor can cover both the range of normal temperature (as shown in Table 2 above) and the range of fevered body temperature.

In some implementations, one or more thermal scanners can detect motion with a wide field of view (120°) and a distance of around five feet, for example, using a motion sensor (e.g., motion sensor 319 in FIG. 3B or motion sensor 427 in FIG. 4D). In some implementations, a thermal scanner may wake up when it detects someone approaching with the motion sensor (e.g., an infrared sensor and/or a proximity sensor). This option can reduce data collection at the edge processor and provide intelligent monitoring without surveillance, reducing energy use and bandwidth traffic. In some implementations, for potential use outdoors, the thermal scanner may be rated IP68 (maximum depth of 4 meters up to 30 minutes) under IEC standard 60529.

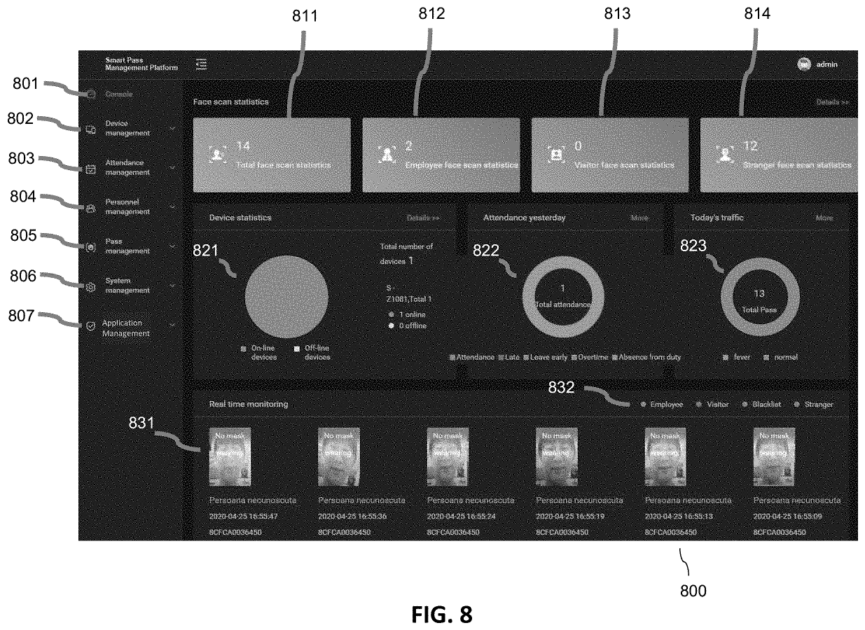

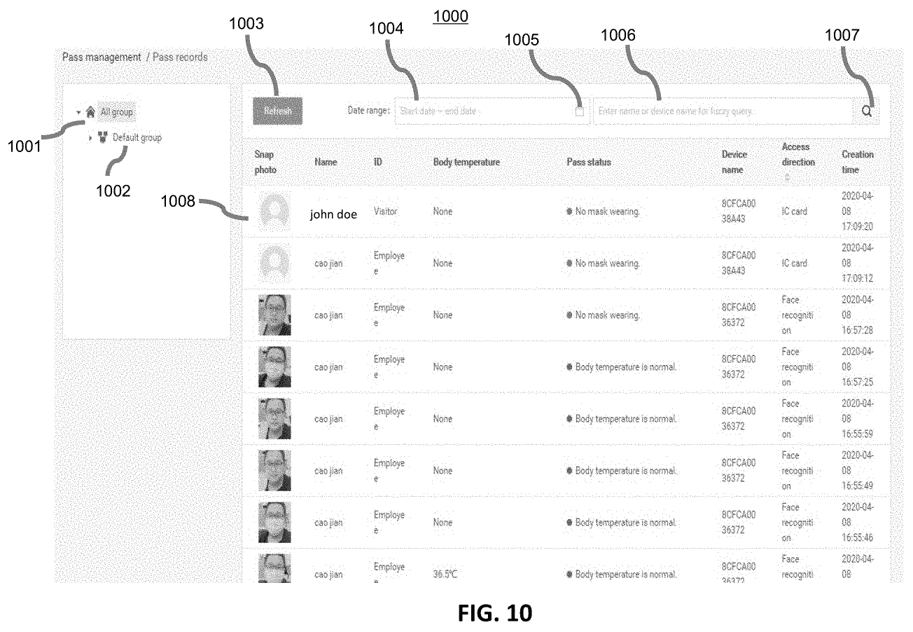

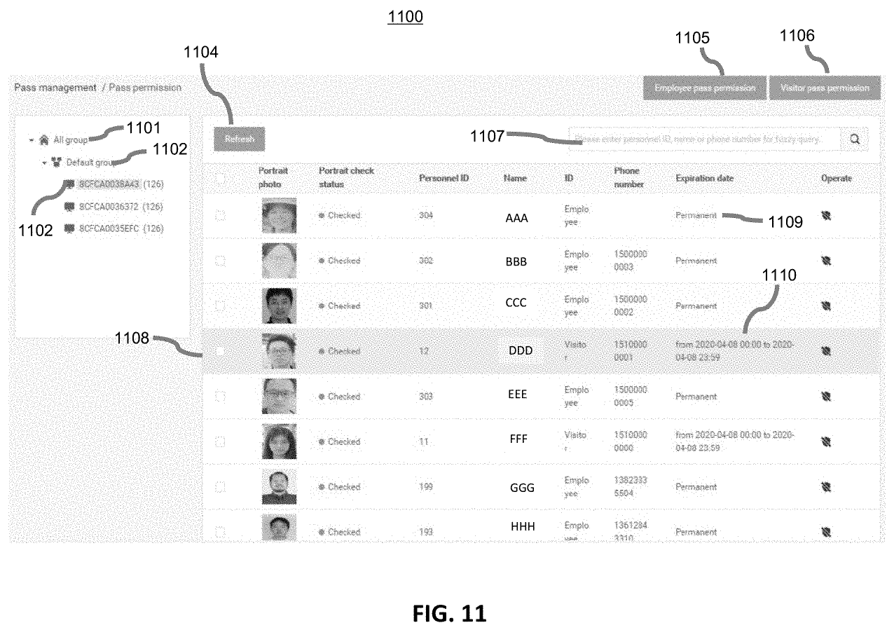

In some implementations, one or more thermal scanners can communicate at ranges of up to 10 meters using a short distance communication (e.g., Bluetooth or NFC) or Wi-Fi. Bluetooth devices do not need to be in direct sight of each other, making Bluetooth communication much more flexible and robust. Since a thermal scanner is Bluetooth-enabled, it can excel at low-bandwidth data transfer, while it is not intended as a replacement for high-bandwidth cabled peripherals. The thermal scanner may use Bluetooth 5.0 and have BLE (Bluetooth Low Energy) technology. For high-bandwidth information transfer, such as that to and from external hard drives or video cameras, the thermal scanner may enable Wi-Fi, for example 802.11ax or Wi-Fi 6 with 2×2 multiple-input and multiple-output (MIMO). This means most users do not need to touch the thermal scanner often. In some implementations, users can just access the dashboards and data (see FIG. 8, FIG. 10, FIG. 11, for example) over wireless or wired LAN, with minute-by-minute updates and ability to export ready-to-use reports in many formats.

FIG. 5A to FIG. 5C are block diagrams each illustrating an example of a temperature monitoring system and a server according to some implementations.

In some implementations, in order to access different data outputs produced by different thermal scanners (e.g., thermal scanners 120-1 to 120-N in FIG. 1) and stored in different databases and different formats, a temperature monitoring system (e.g., the system 100 in FIG. 1) may connect to a server (e.g., the server 500 in FIG. 1) via a network. In some implementations, an application programming interface (API) may be provided in the server so that the server can connect to different databases to access different data outputs produced by different thermal scanners.

Referring to FIG. 5A to FIG. 5C, systems 100A, 100B, and 100C may have configurations similar to those of the system 100 in FIG. 1, and servers 500A, 500B, 500C may have configurations similar to those of the server 500 in FIG. 1. In some implementations, the servers 500A, 500B, 500C may be implemented as a remote cloud server 490 as shown in FIG. 4A. In some implementations, the server 500A may include a local database 502A so that data stored at the local database 502 can be accessed through an API 501A. In some implementations, the server 500B may include an API 500B that is implemented as a thin layer to access a plurality of remote databases 510B, 520B, and 530B. In some implementations, the databases 510B, 520B, 530B may be a plurality of third party or legacy systems, and the server 500B can integrate the databases through a single API. The configuration shown in FIG. 5C is a hybrid approach of the two approaches shown in FIG. 5A and FIG. 5B. That is, in some implementations, the server 500C may include a local database 502C and an API 501C that can access both the local database 502C and a plurality of remote databases 510C, 520C.

In some implementations, the APIs shown in FIG. 5A to FIG. 5C may be implemented using a query language, e.g., GraphQL which usually operates over HTTPS. The APIs shown in FIG. 5A to FIG. 5C can be implemented such that front-end programmers can use the APIs using a combination of component library and a query client (e.g., React and urql, or React and Apollo). Back-end programmers can implement the APIs using a combination of a query language and a programming language (e.g., GraphQL and Java, GraphQL and Ruby, GraphQL and Python, GraphQL and Scala, GraphQL and Go, GraphQL and Elixir, GraphQL and Node).

FIG. 6A to FIG. 6C are diagrams illustrating an example of image processing for face recognition according to some implementations.

In some implementations, a workplace entry management system (e.g., the system 100 in FIG. 1) may identify and/or classify a person upon entry using face recognition. Referring to FIG. 6A to FIG. 6C, in some implementations, the system may perform image processing on a first face image (e.g., an image shown in FIG. 6C) of a person having an ID card, taken upon entry, to detect facial features using a plurality of landmarks 602, 603, 604, 605, 606 each of which is a map of points that surround a feature of the face, e.g., eyebrows 602, eyes 603, nose 604, mouth 605, jawline 606, etc. In some implementations, the system may compare the detected facial features with facial features of a second face image (e.g., a face image 601 in FIG. 6A) of a person having the same ID card, which has been previously uploaded to the system. If the facial features of the two face images are substantially the same, the system may determine that face recognition is successful; otherwise the system may determine that face recognition fails.

FIG. 7A to FIG. 7C are diagrams illustrating an example of image processing for mask detection according to some implementations.

When a person wears a face mask or a face covering, this may obscure more than half of these landmarks, making face recognition difficult through conventional facial detection programs (e.g., DLib tools). For example, referring to FIG. 7B, due to a face mask, there may be a fewer number of landmarks 702, 703, 705, 706 each of which is a map of points that surround a feature of the face, e.g., eyebrows 702, eyes 703, jawline 705, ear 706. In some implementations, the system may determine that a person wears a face mask or a face covering if the number of landmarks recognized or detected from a first picture of the person (e.g., FIG. 7C) is fewer than the number of landmarks recognized or detected from a normal picture of a person who does not wear a face mask/covering. In some implementations, if it is determined that a person from the first picture wears a face mask/covering (which corresponds to a landmark 704 in FIG. 7B), the system may adjust or modify the (standard) landmarks based on a shape of a face mask so as to primarily use landmarks around eyes (e.g., landmark 703 in FIG. 7B) and eyebrows (e.g., landmark 702 in FIG. 7B). Using the adjusted or modified landmarks, the system may detect the facial features from the first picture, and recognize the face, if the facial features of the first picture of the person (e.g., FIG. 7C) substantially match with facial features detected from a second picture (e.g., 701 in FIG. 7A).

In some implementations, the system may use a machine learning algorithm to detect such features of the face from the face image. Such machine learning models or techniques may include, but not limited to, supervised learning, unsupervised learning, semi-supervised learning, regression algorithms, instance-based algorithms, regularization algorithms, decision tree algorithms, Bayesian algorithms, clustering algorithms, artificial neural networks, deep learning algorithms. dimension reduction algorithms (e.g., PCA), ensemble algorithms, support vector machines (SVM), and so on.

In some implementations, the system may use deep learning algorithms to predict and recognize individuals based on images of their ears to supplement landmark-based detections (particularly when a clear face picture as the second picture is uploaded so that a machine learning model can sufficiently learn from the clear face picture). In some implementations, such ear-based face recognition can be implemented using a large image database and a generative adversarial network (GAN)-based model which is constructed based on accepted biometric practices. Ear images can be effectively utilized for person identification, age estimation, and gender classification, etc. because use of ear images for such purposes are accepted biometric practices.

FIG. 8 is an example user interface for console according to some implementations. In some implementations, a console manager (e.g., the console manager 106 in FIG. 1) of a temperature monitoring system (e.g., the system 100 in FIG. 1) may perform console management to provide a dashboard or console interface 800 to display data related with today's pass and real-time monitoring of body temperature of people upon entry.

Referring to FIG. 8, the user interface 800 may display a plurality of main menu items 802, 803, 804, 804, 805, 806, 807 which correspond to console management, device management, attendance management, personnel management, pass management, system management, etc. of the system 100, respectively. The user interface 800 may display face scan statistics 811, 812, 813, 814. The statistics 811 indicates a total number of thermal scans performed on that day. The statistics 812 indicates a number of thermal scans performed on employees of an organization on that day. The statistics 813 indicates a number of thermal scans performed on visitors to the organization on that day. The statistics 814 indicates a number of thermal scans performed on strangers (who is not employee nor visitor) to the organization on that day.

The user interface 800 may display device statistics 821 which indicates the number of devices online and the number of devices offline using a pie chart, for example. The user interface 800 may display attendance statistics 822 which indicates the number of (on-time) attendance, the number of late attendances, the number of people leaving early, the number of over-timers, and the time off duty, using a pie chart, for example. The user interface 800 may display (temperature) pass statistics 823 which indicates the number of people whose body temperature exceeds a threshold temperature and the number of people having a normal body temperature, using a pie chart, for example. The user interface 800 may display a real time monitoring status 831 of a plurality of persons scanned, which includes information of each person, such as (1) time of being scanned, (2) whether each person is an employee, visitor, blacklisted, or stranger using corresponding color codes 832, (3) body temperature of each person, (4) whether each person wears a face mask/covering, and/or (5) quick access to view details.

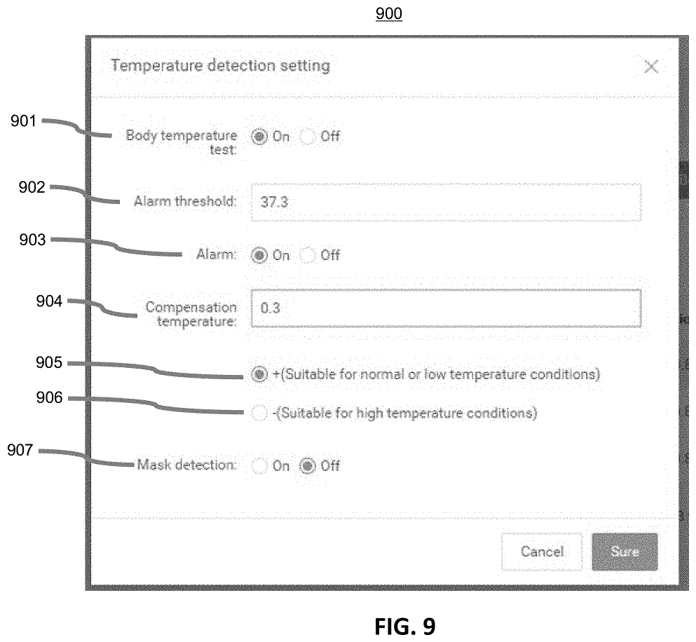

FIG. 9 is an example user interface for temperature detection setting according to some implementations. In some implementations, a device manager (e.g., the device manager 104 in FIG. 1) of a temperature monitoring system (e.g., the system 100 in FIG. 1) may perform device management to select a device (e.g., a thermal scanner) and set parameters for temperature detection. Referring to FIG. 9, the system may display a user interface 900 for setting parameters for temperature detection. The parameters may include a temperature detection switch 901 (default on, for example), an alarm threshold 902 (default 37.3° C., for example), an alarm switch 903, a compensation temperature 904 (default value of 0.3° C. for addition, for example) and and/or mask settings 907 (default off, for example). In some implementations, the system may enable a user to choose a menu item for device management (e.g., menu item 802 in FIG. 8). If the menu item is chosen, the system may display a user interface for a user to select a device in a device list (not shown), or to select a group of devices (not shown), and to click a body temperature detection link (not shown) to set the parameters of temperature detection (using the user interface 900) for the selected device or the selected group of devices.

In some implementations, the system may perform body temperature settings including settings for a body temperature detection switch (e.g., temperature detection switch 901), a compensation temperature (e.g., compensation temperature 904), an alarm threshold (e.g., alarm threshold 902), and/or a body temperature alarm (e.g., alarm switch 903). The body temperature detection switch setting may enable a user to control a body temperature detection function by turning the function on or off with the default on. Setting the body temperature detection switch to a value of “on” may indicate that during identification or recognition of personnel traffic, the system displays (in a user interface) and/or broadcasts a body temperature value of a person after the face of the person is recognized. Setting the body temperature detection switch to a value of “off” may indicate that during identification or recognition of personnel traffic, the system automatically hide the outline of the face of a person in a user interface, and the interface does not detect a body temperature of the person after the face is recognized.

The compensation temperature setting may enable a user to set a compensation temperature such that when the ambient temperature may affect a detected body temperature, the detected body temperature can be automatically adjusted using the compensation temperature. In some implementations, the compensation temperature setting may enable a user to select an addition or a subtraction. For example, if a default compensation temperature value is 0.3° C., and a default selection is an addition, during identification or recognition of personnel traffic, a detected body temperature (e.g., 36.1° C.) can be automatically adjusted by adding 0.3° C. and the adjusted body temperature (e.g., 36.4° C.) can be displayed. In some implementations, the compensation temperature setting may enable a user to set a range of compensation temperature. For example, if the range is set to a range from 0° C. to 1° C., a maximum of one decimal can be reserved.

The alarm threshold setting may enable a user to set an alarm threshold to control body temperature detection. In some implementations, the alarm threshold setting may enable a user to set a range of alarm threshold. For example, if a default alarm threshold is 37.3° C. and a range between 30.0° C. and 45.0° C., only numbers between 30.0° C. and 45.0° C. can be entered, and up to one decimal can be reserved. The body temperature alarm setting may enable a user to select on or off to turn on or off a body temperature alarm so that when the body temperature alarm is turned on, if an identified body temperature exceeds a threshold, an alarm may be issued. In some implementations, the body temperature alarm setting may enable a user to control a body temperature alarm function to turn on or off the body temperature alarm function with the default being on. For example, when the body temperature alarm is on, if a detected body temperature is higher than the threshold, the system may display on a user interface the body temperature and emit or issue an alarm sound, for example. On the other hand, when the body temperature alarm is on, if the body temperature is lower than the threshold, the system may not emit or issue an alarm. When the body temperature alarm is off, no matter the body temperature is higher or lower than the threshold, the system may not emit or issue an alarm.

In some implementations, body temperature settings may include settings for mask detection (e.g., mask settings 907 in FIG. 9). The system may enable a user to control a mask detection function (e.g., image processing for detecting a face mask/covering as shown in FIG. 7A to FIG. 7C). The system may enable a user to choose to turn on or off the mask detection function with the default being off. When the mask detection function is turned on, the system may perform image processing for detecting a face mask/covering. If the system detects or recognize that a person does not wear a mask, the system may set a background color to red and display a message a warning message or an image (e.g., message or image indicating “Please wear a mask”) in a red background. The system may control an access device (e.g., gates 130-1 to 130-N in FIG. 1) to prohibit the access of the person. For example, the system may cause the device manager 104 to control a gate to be closed. In some implementations, the system may control a voice I/O device (e.g., speaker) to emit an alarm sound or broadcast a voice message (e.g., “Please wear a mask”). When the mask detection function is turned off, the system does not perform image processing for detecting a face mask/covering.

In some implementations, a personnel manager (e.g., the personnel manager 108 in FIG. 1) of a temperature monitoring system (e.g., the system 100 in FIG. 1) may perform personnel management. In some implementations, the system may enable a user to choose a menu item for personnel management (e.g., menu item 804 in FIG. 8). If the menu item for personnel management is chosen, the system may display (1) a user interface to perform an employee creation operation (not shown), or (2) a user interface to perform a visitor creation operation (not shown).

Using (1) the user interface to perform the employee creation operation, the system may enable a user to add employee information individually. For example, the system may enable a user to add a single employee to an employee list (not shown) by entering the personnel ID, name, gender, belonging group, phone number, ID card number, IC card number, place of birth, date of birth, contact address, notes, etc. The system may enable a user to add a face recognition photo for face recognition (e.g., the photos shown in FIG. 6A and FIG. 7A) and to click a save button to complete the employee creation operation.

Using (2) the user interface to perform the visitor creation operation, the system may enable a user to add visitor information individually. For example, the system may enable a user to add a single visitor by entering a visitor ID, name, gender, affiliation group, mobile phone number, ID card number, IC card number, ethnicity, nationality, date of birth, contact address and remarks, etc. The system may enable a user to add a face recognition photo for face recognition (e.g., the photos shown in FIG. 6A and FIG. 7A) and to click a save button to complete the visitor creation operation.

In some implementations, using a user interface to perform the blacklist creation operation, the system may enable a user to add individual information to a blacklist. For example, the system may enable a user to add a single person to the blacklist by entering a blacklist ID, name, gender, affiliation group, mobile phone number, ID card number, IC card number, ethnicity, nationality, date of birth, contact address and remarks, etc. The system may enable a user to add a face recognition photo for face recognition (e.g., the photos shown in FIG. 6A and FIG. 7A) and to click a save button to complete the blacklist creation operation.

FIG. 10 is an example user interface for pass management according to some implementations. In some implementations, a pass manager (e.g., the pass manager 110 in FIG. 1) of a temperature monitoring system (e.g., the system 100 in FIG. 1) may perform pass management. In some implementations, the system may enable a user to choose a menu item for pass management (e.g., menu item 805 in FIG. 8). If the menu item for pass management is chosen, the system may display (1) a user interface to display pass records (e.g., user interface 1000 shown in FIG. 10) and (2) a user interface to give or revoke pass permissions (e.g., user interface 1100 shown in FIG. 11).

Referring to FIG. 10, in some implementations, the system may perform pass management to display pass records (or travel records) using the user interface 1000. In some implementations, the pass records can be grouped and filtered by the device. In some implementations, the system may enable a user to select a device group 1002 among all device group 1001. If the user further selects a particular device (e.g., a thermal device), the system may display pass records collected or identified from the particular device. Otherwise, if the user does not select any device, the system may display pass records collected or identified from all devices (as shown in FIG. 10).

In some implementations, the system may enable a user to query data of the pass records and/or export the data by day. For example, the data of the current day is displayed by default (as shown in FIG. 10), and the data can be exported to an external disk, e.g., a U disk. The system may enable a user to query data of the pass records with a date range 1004 (e.g., start date to end date) or a device name or person name 1005. In response to a user entering a particular date range or a particular name and clicking a submit button 1007, the system may display pass records satisfying or matching with the particular date range or the particular name.

In some implementations, the system may display pass records (per device, for example) which are identification records on the device. For example, as shown in FIG. 10, each pass record may include at least one of snapshot of the person, name of a person, identity of a person (e.g., whether the person is employee, visitor, stranger), body temperature of the person, pass status or pass state (e.g., whether body temperature is normal or abnormal, and/or whether the person wears a mask or not), name of a device scanning the person, method or direction of access (e.g., using IC card, face recognition, etc.), time of passage, among others. In some implementations, there are three pass states: normal body temperature, abnormal body temperature and no mask. In the pass records displayed, pass status for body temperature values that are greater than or equal to 37.3 degrees may be displayed in red font or with a red image, pass status for values less than 37.3 degrees may be displayed in green font or with a green image, and pass status for no temperature data may be displayed as “none”.

FIG. 11 is an example user interface for displaying pass permission records (or access rights records) according to some implementations.

In some implementations, the system (e.g., the system 100 in FIG. 1) may determine or recognize or confirm passage of a person upon entry. In some implementations, the system may perform such pass recognition of a person based on at least one of (1) an identity of the person, (2) a body temperature of the identified person, or (3) whether the person wears a mask. For example, the system may perform pass recognition of a person (and control a gate to be opened) if a pass permission record (e.g., pass permission record 1108 in FIG. 11) identified by the identity of the person indicates that pass permission is given to the person and (1) the body temperature of the person is lower than a temperature threshold or (2) the person wears a mask. In another example, the system may not perform pass recognition of a person (and control a gate to be closed) if the person does not wear a mask or the body temperature of the person exceeds a temperature threshold, even if a pass permission record identified by the identity of the person indicates that pass permission is given to the person.

Referring to FIG. 11, the system may display pass permission records using the user interface 1100. In some implementations, the pass permission records can be grouped and filtered by the device (e.g., a thermal scanner). In some implementations, the system may enable a user to select a device group 1102 among all device group 1101. If the user further selects a particular device 1102, the system may display pass permission records collected or identified from the particular device (as shown in FIG. 10). Otherwise, if the user does not select any device, the system may display pass permission records collected or identified from all devices.

In some implementations, the user interface 1100 may include a refresh button 1104 to display pass permission records as updated at the current time. In some implementations, the system may enable a user to query data of the pass permission records. For example, the system may enable a user to query data of the pass permission records with information 1107 such as a personal ID, name or phone number of a particular person. In response to a user submitting the information 1107, the system may display pass permission records satisfying or matching with the submitted information.

In some implementations, as shown in FIG. 11, each pass permission record (e.g., access right record) may include at least one of portrait photo of the person (which may be different from a snapshot photo taken upon entry), check status of portrait photo, personal ID of the person, name of the person, identity of a person (e.g., whether the person is employee or visitor), phone number of the person, name of a device scanning the person, method or direction of access (e.g., using IC card, face recognition, etc.), expiration date of pass permission, among others. For example, the expiration date of a particular person may be set to “permanent” indicating that a pass permission is permanently given to the particular person (see the expiration date 1109). The expiration date of a particular person may be set to a period of date/time indicating that a pass permission is given only during that period (see the expiration date 1110).

In some implementations, the user interface 1100 may include an employee permission button 1105 to display a user interface (not shown) to give pass permission to, or revoke pass permission pass permission from, a particular employee, and to update the pass permission records accordingly. Similarly, the user interface 1100 may include a visitor permission button 1106 to display a user interface (not shown) to give pass permission to, or revoke pass permission pass permission from, a particular visitor, and to update the pass permission records accordingly.

In some implementations, a system manager (e.g., the system manager 112 in FIG. 1) of a temperature monitoring system (e.g., the system 100 in FIG. 1) may perform system management. In some implementations, the system may enable a user to choose a menu item for system management (e.g., menu item 806 in FIG. 8). If the menu item for system management is chosen, the system may display (1) a user interface to manage a group structure (not shown), (2) a user interface to perform a role management (not shown), (3) a user interface to perform business management (not shown), (4) a user interface to display system logs (not shown), or (5) a user interface to perform system settings (not shown).

Using (1) the user interface to manage the group structure, the system may enable a user to manage a group structure and organization user information (of an organization). For example, the user may be able to manage a group structure of an enterprise (e.g., hierarchical relationship) and manage enterprise user information in the enterprise.

Using (2) the user interface to manage the role management, the system may enable a user to control various business function operations of users in the system (e.g., system administrators or other users that can login to the system). For example, using the user interface to manage the role management, the user can set access rights to system resources or data (e.g., device list, pass records, pass permission records, etc.) for a particular user in the system.

Using (3) the user interface to perform business management, the system may enable a user (e.g., a system administrator or a super administrator) to create and manage corporate accounts in the system. In some implementations, the business management can be only operated by a system administrator (or super administrator). For example, each corporate account may have corporate administrator rights to log in to the system. After logging in to the system, the account can manage the organizational structure, users, and roles within the enterprise, and can view and manage all business data created by the enterprise users.

Using (4) the user interface to display system logs, the system may enable a user to display a system log list that contains the user's operation date, function modules, log details, operation results, operator and other information records during the use of the system.

Using (5) the user interface to perform system settings, the system may enable a user to set system parameters such as background server port, message service port, and/or database service port configuration.

In some implementations, an attendance manager (e.g., the attendance manager 114 in FIG. 1) of a temperature monitoring system (e.g., the system 100 in FIG. 1) may perform attendance management. In some implementations, the system may enable a user to choose a menu item for attendance management (e.g., menu item 803 in FIG. 8). If the menu item for attendance management is chosen, the system may display (1) a user interface to manage attendance rules (not shown), (2) a user interface to display attendance records (not shown), or (3) a user interface to display attendance statistics (not shown).

Using (1) the user interface to manage attendance rules, the system may enable a user to add, modify and/or delete related rules including shifts, holidays, public holidays, and device groups, and the like.

Using (2) the user interface to display attendance records, the system may enable a user to query the attendance records of all employees by time period and group, track employees by attendance status, query the daily attendance within a custom time period by employee name and ID, and/or query the attendance of employees by date record and export the query result list file to download locally. In some implementations, each attendance record may include name of a person, date, employee group, employee ID, body temperature, face mask (e.g., whether the person wears a mask on that day), and/or attendance status (e.g., attendance or absence), etc.

Using (3) the user interface to display attendance statistics, the system may enable a user to query or export the data of normal and abnormal attendance of employees at all times or within a specified range of time, working days, public holidays and overtime data on holidays. In some implementations, the user can query the data of normal and abnormal attendance of employees with pass status (e.g., whether body temperature is normal or abnormal, and/or whether the person wears a mask or not). In some implementation, the system may enable a user to select all groups of employees or a particular group of employees to display attendance statistics of all employees or attendance statistics of employees of that particular group. In some implementations, attendance statistics of an employee may include at least one or more of name of the employee, employee ID, number of days with normal attendance, number of days with late attendance, number of days with absence, number of days with leaving early, number of days with overtime on working days, number of days of overtime on holidays, number of days with abnormal temperatures, number of without face mask, etc. In some implementations, the system may provide a search bar including a search box and an enter button (not shown) so that a user can enter an employee name or employee ID in the search box and click the enter button to query the employee's attendance data. In some implementations, the system may provide a search bar (not shown) for performing a range search the employee's attendance data.

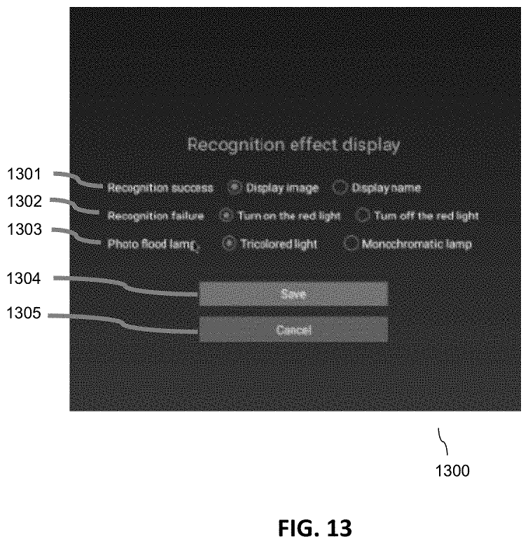

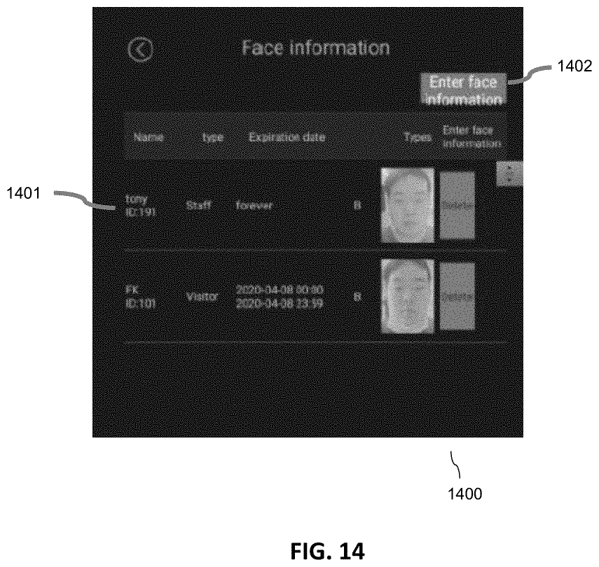

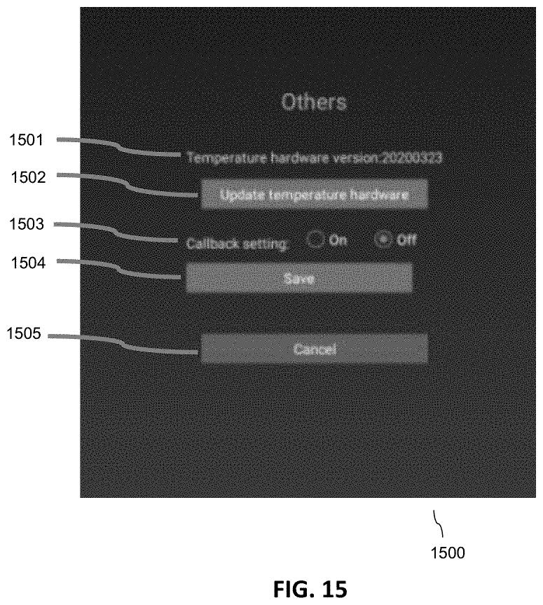

In some implementations, an application manager (e.g., the application manager 114 in FIG. 1) of a temperature monitoring system (e.g., the system 100 in FIG. 1) may perform application management. In some implementations, the system may enable a user to choose a menu item for application management (e.g., menu item 807 in FIG. 8). If the menu item for application management is chosen, the system may display (1) a user interface to perform screen saver settings (not shown), (2) a user interface to perform display settings on recognition effects (see FIG. 13), (3) a user interface to display face information (see FIG. 14) or (4) a user interface to update temperature measurement firmware (see FIG. 15).

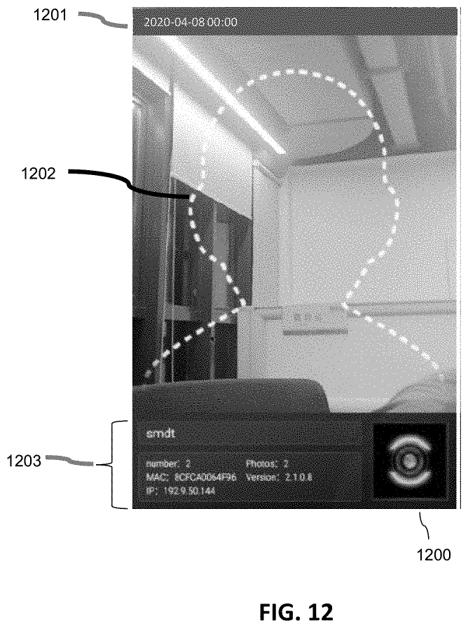

Using (1) the user interface to perform screen saver settings, the system may enable a user to set whether a face recognition is required, and/or set brightness of screen saver, for example. In some implementations, if a face recognition is not required, the system may require a screen saver to be displayed. If a face recognition is required, the system may cause the screen to jump to a face recognition page of the person (see FIG. 12). For example, the system may display the face recognition page within 30 seconds if a face recognition is required; otherwise if a face recognition is not required, the system may display a screen saver within 30 seconds.

FIG. 12 is an example user interface for displaying a face recognition page according to some implementations. In some implementations, a face recognition page 1200 of a person may include a top information bar 1201, a camera screen 1202, and/or a bottom information bar 1203. The top information bar 1201 may indicate time information that is automatically synchronized with a server time and day of the week. The camera screen 1202 may be displayed in full screen, and upon completion of face recognition, a recognition result may be displayed when passing through. The bottom information bar 1203 may include one or more of company name, number of people (e.g., the total number of people in the device (or a thermal scanner)), number of photos (e.g., the number of photos is the number entered in the face database), medium access control (MAC) address of the current device, or IP address of a client (e.g., a client connecting to the system 100 in FIG. 1) and version number of the client.

FIG. 13 is an example user interface for display settings on recognition effects according to some implementations. In some implementations, the system may display a user interface 1300 that enables a user to set the effect of face recognition. In some implementations, the user interface 1300 may include a user interface to display an image or a name when the recognition is successful (the default value is displaying the image). The user interface 1300 may include a user interface to turn on or off a red light when the recognition fails (the default value is turning on the red light). The user interface 1300 may include a user interface to set a tri-colored light or a monochromatic light as light of photo flood lamp (the default value is the tri-colored light), as shown in FIG. 13.

FIG. 14 is an example user interface for displaying face information according to some implementations. In some implementations, the system may display a user interface 1400 that displays face information items (e.g., information item 1401) of a face database (e.g., the databases 118 in FIG. 1) relating to the current device. Each face information item relating to the face of a person may include the name of the person, identity of the person, expiration date, type of the person (e.g., staff, employee, or visitor), and face image. In some implementations, the system may enable a user to delete face information items and/or add new face information items (e.g., using a button 1402).

FIG. 15 is an example user interface for updating temperature measurement firmware according to some implementations. In some implementations, the system may display a user interface 1500 to update temperature measurement firmware (e.g., temperature measurement module 102 in FIG. 1). The user interface 1500 may display version information 1501 of the current temperature measurement firmware. The user interface 1500 may display an update firmware button 1502 so that upon clicking the update firmware button 1502, the firmware of the temperature measurement module can be manually upgraded. For example, upon clicking the update firmware button 1502, the system may enable a user to first insert a portable drive (e.g., USB hard disc drive or a U disk, choose a temperature measurement module upgrade function of application settings, and select firmware that can be upgraded for manual upgrade. After upgrade to new firmware of the temperature measurement module, the system may enable a user to view the version number of the new firmware of the temperature measurement module (e.g., the version information 1501). In some implementations, the user interface 1500 may include a user interface 1503 that enables a user to turn on or off a callback function. If the callback function is turned on, the firmware of the temperature measurement module can be automatically upgraded by setting a callback address in application settings. The callback address may indicate an Internet address at which new firmware of the temperature measurement module can be accessed. When the callback function is turned on (e.g., using the user interface 1503), the system may enable a user to enter a callback address. When the callback function is turned off, the system may turn off the callback function and may not automatically upgrade the firmware of the temperature measurement module. The system may enable a user to save the current setting as displayed in the user interface 1500 (e.g., using a save button 1504) or discard the current setting as displayed in the user interface 1500 (e.g., using a cancel button 1505).

In some implementations, a system (e.g., temperature monitoring system 100 in FIG. 1) may include at least one processor (e.g., processor 210 in FIG. 2). The at least one processor may be configured to cause a first device (e.g., one or more thermal scanners 120-1 to 120-N) to monitor a body temperature of a first person, determine, responsive to the monitoring, as a first determination result, whether the monitored body temperature exceeds a predetermined threshold (e.g., alarm threshold 902 in FIG. 9), perform image processing on an image of the first person (see FIG. 7A to FIG. 7C), determine, based on a result of the image processing, as a second determination result, whether the first person wears a face mask, and control a second device (e.g., one or more gates 130-1 to 130-N in FIG. 1) based on at least one of the first determination result or the second determination result. For example, the system may control a gate to be closed if (1) the body temperature of the person exceeds a temperature threshold or (2) the person does not wear a mask, even if a pass permission record identified by the identity of the person indicates that pass permission is given to the person.

In some implementations, the first device may be a thermal scanner (e.g., one or more thermal scanners 120-1 to 120-N). In some implementations, the second device may be a gate configured to open or close (e.g., one or more gates 130-1 to 130-N in FIG. 1). In controlling the second device, the at least one processor may be configured to control, based on at least one of the first determination result or the second determination result, the gate to open so that the first person can pass the gate. For example, the system may control a gate to be opened if (1) the body temperature of the person is lower than a temperature threshold or (2) the person wears a mask when a pass permission record (e.g., pass permission record 1108 in FIG. 11) identified by the identity of the person indicates that pass permission is given to the first person.

In some implementations, the second device may be a speaker (e.g., I/O components 250 in FIG. 2). In controlling the second device, the at least one processor may be configured to control, based on at least one of the first determination result or the second determination result, the speaker to emit an alarm sound or output a recording voice conveying a particular message (e.g., “Please wear a face mask”).

In some implementations, the second device may be a display (e.g., I/O components 250 in FIG. 2). In controlling the second device, the at least one processor may be configured to control, based on at least one of the first determination result or the second determination result, the display to display at least one of a message or an image (e.g., “Please wear a face mask”).

In some implementations, the at least one processor may be further configured to set a compensation temperature (e.g., compensation temperature 0.3 in FIG. 9) based on an ambient temperature, and adjust the monitored body temperature based on the compensation temperature (e.g., a detected body temperature can be automatically adjusted by adding the compensation temperature thereto).

In some implementations, the first device may be one thermal scanner of a plurality of different kinds of thermal scanners (e.g., one or more thermal scanners 120-1 to 120-N). In monitoring the body temperature of the first person, the at least one processor may be configured to connect one database of a plurality of databases (e.g., databases 510B, 520B, 530B in FIG. 5B) via a server (e.g., the server 500B in FIG. 5B) to obtain second information about the one thermal scanner (e.g., data outputs produced by the one thermal scanner), and monitor the body temperature of the first person based on the second information.

In some implementations, an application programming interface (API) that integrates the plurality of databases (e.g., APIs 501A, API in the server 500B, API 501C in FIG. 5A to FIG. 5C) may be provided. In connecting the one database of the plurality of databases via the server, the server may be configured to execute the API to connect the one database.

In some implementations, in performing the image processing on the image of the first person, the at least one processor may be configured to select, based on a shape of a face mask, a set of landmarks (e.g., landmarks 702, 703, 705 in FIG. 7B) from among a plurality of landmarks (e.g., landmarks 602, 603, 604, 605, 606 in FIG. 6B) each representing a map of points that surround a feature of a face of a person, and identify, based on the selected set of landmarks, a plurality of features of a face of the first person. In determining whether the first person wears a face mask, the at least one processor may be configured to determine, based on the identified features of the face of the first person, whether the first person wears a face mask.

In some implementations, the selected set of landmarks may include at least one of eyes, eyebrows, or ears (e.g., landmarks 703, 702, 706 in FIG. 7B). The at least one processor may be further configured to detect, based on the identified features of the face of the first person, the face of the first person.

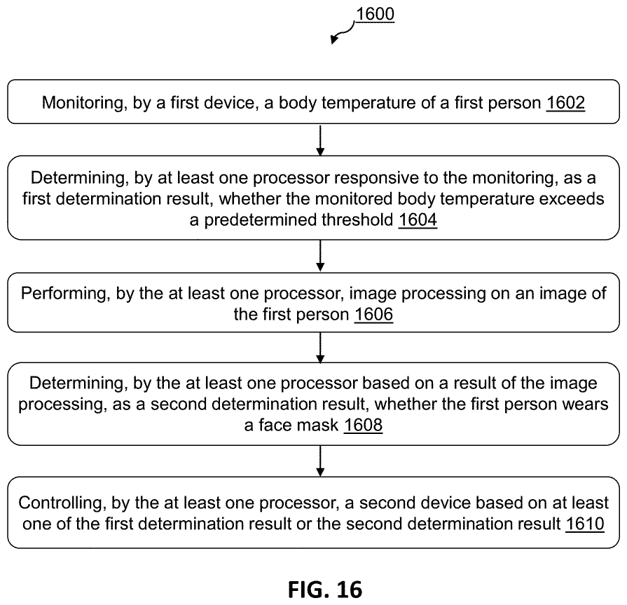

FIG. 16 is a flowchart illustrating an example methodology for monitoring body temperature using one or more thermal scanners according to some implementations. In this example methodology, the process 1600 begins at step 1602 by monitoring, by at least one processor (e.g., processor 210 in FIG. 2), a body temperature of a first person using a first device (e.g., one or more thermal scanners 120-1 to 120-N). In some implementations, the first device may be a thermal scanner.

In some implementations, the first device may be one thermal scanner of a plurality of different kinds of thermal scanners (e.g., one or more thermal scanners 120-1 to 120-N). In monitoring the body temperature of the first person, the at least one processor may connect one database of a plurality of databases (e.g., databases 510B, 520B, 530B in FIG. 5B) via a server (e.g., the server 500B in FIG. 5B) to obtain second information about the one thermal scanner (e.g., data outputs produced by the one thermal scanner), and monitor the body temperature of the first person based on the second information.

In some implementations, an application programming interface (API) that integrates the plurality of databases (e.g., APIs 501A, API in the server 500B, API 501C in FIG. 5A to FIG. 5C) may be provided. In connecting the one database of the plurality of databases via the server, the server may be configured to execute the API to connect the one database.

At step 1604, in some implementations, the at least one processor may determine, responsive to the monitoring, as a first determination result, whether the monitored body temperature exceeds a predetermined threshold (e.g., alarm threshold 902 in FIG. 9).

At step 1606, the at least one processor may perform image processing (see FIG. 7A to FIG. 7C) on an image of the first person (see FIG. 7A to FIG. 7C). In some implementations, in performing the image processing on the image of the first person, the at least one processor may select, based on a shape of a face mask, a set of landmarks (e.g., landmarks 702, 703, 705 in FIG. 7B) from among a plurality of landmarks (e.g., landmarks 602, 603, 604, 605, 606 in FIG. 6B) each representing a map of points that surround a feature of a face of a person, and identify, based on the selected set of landmarks, a plurality of features of a face of the first person.

At step 1608, the at least one processor may determine, based on a result of the image processing, as a second determination result, whether the first person wears a face mask. In determining whether the first person wears a face mask, the at least one processor may determine, based on the identified features of the face of the first person, whether the first person wears a face mask. In some implementations, the selected set of landmarks may include at least one of eyes, eyebrows, or ears (e.g., landmarks 703, 702, 706 in FIG. 7B). The at least one processor may further detect, based on the identified features of the face of the first person, the face of the first person.

At step 1610, the at least one processor may control a second device (e.g., one or more gates 130-1 to 130-N in FIG. 1) based on at least one of the first determination result or the second determination result. For example, the system may control a gate to be closed if (1) the body temperature of the person exceeds a temperature threshold or (2) the person does not wear a mask, even if a pass permission record identified by the identity of the person indicates that pass permission is given to the person.

In some implementations, the second device may be a gate configured to open or close (e.g., one or more gates 130-1 to 130-N in FIG. 1). In controlling the second device, the at least one processor may control, based on at least one of the first determination result or the second determination result, the gate to open so that the first person can pass the gate. For example, the system may control a gate to be opened if (1) the body temperature of the person is lower than a temperature threshold or (2) the person wears a mask when a pass permission record (e.g., pass permission record 1108 in FIG. 11) identified by the identity of the person indicates that pass permission is given to the first person.

In some implementations, the second device may be a speaker (e.g., I/O components 250 in FIG. 2). In controlling the second device, the at least one processor may control, based on at least one of the first determination result or the second determination result, the speaker to emit an alarm sound or output a voice conveying a particular message (e.g., “Please wear a face mask”).

In some implementations, the second device may be a display e.g., I/O components 250 in FIG. 2). In controlling the second device, the at least one processor may control, based on at least one of the first determination result or the second determination result, the display to display at least one of a message or an image (e.g., “Please wear a face mask”).

In some implementations, the method may include setting, by the at least one processor, a compensation temperature (e.g., compensation temperature 0.3 in FIG. 9) based on an ambient temperature. The method may include adjusting, by the at least one processor, the monitored body temperature based on the compensation temperature (e.g., a detected body temperature can be automatically adjusted by adding the compensation temperature thereto).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated by one of skill in the art the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A method, comprising:
monitoring, by at least one processor, a body temperature of a first person using a first device;
determining, by the at least one processor responsive to the monitoring, as a first determination result, whether the monitored body temperature exceeds a predetermined threshold;
performing, by the at least one processor, image processing on an image of the first person;
determining, by the at least one processor based on a result of the image processing, as a second determination result, whether the first person wears a face mask; and
controlling, by the at least one processor, a second device based on at least one of the first determination result or the second determination result.

2. The method according to claim 1, wherein the first device is a thermal scanner.

3. The method according to claim 1, wherein
the second device is a gate configured to open or close, and
controlling the second device comprises:
controlling, based on at least one of the first determination result or the second determination result, the gate to open so that the first person can pass the gate.

4. The method according to claim 1, wherein
the second device is a speaker, and
controlling the second device comprises:
controlling, based on at least one of the first determination result or the second determination result, the speaker to emit an alarm sound or output a voice conveying a particular message.

5. The method according to claim 1, wherein
the second device is a display, and
controlling the second device comprises:
controlling, based on at least one of the first determination result or the second determination result, the display to display at least one of a message or an image.

6. The method according to claim 1, further comprising:
setting, by the at least one processor, a compensation temperature based on an ambient temperature; and
adjusting, by the at least one processor, the monitored body temperature based on the compensation temperature.

7. The method according to claim 1, wherein
the first device is one thermal scanner of a plurality of different kinds of thermal scanners, and
monitoring the body temperature of the first person comprises:
connecting one database of a plurality of databases via a server to obtain second information about the one thermal scanner; and
monitoring the body temperature of the first person based on the second information.

8. The method according to claim 7, further comprising:
providing an application programming interface (API) that integrates the plurality of databases,
wherein connecting the one database of the plurality of databases via a server comprises executing, by the server, the API to connect the one database.

9. The method according to claim 1, wherein
performing the image processing on the image of the first person comprises:
selecting, based on a shape of a face mask, a set of landmarks from among a plurality of landmarks each representing a map of points that surround a feature of a face of a person; and
identifying, by the at least one processor based on the selected set of landmarks, a plurality of features of a face of the first person, and
determining whether the first person wears a face mask comprises:
determining, by the at least one processor based on the identified features of the face of the first person, whether the first person wears a face mask.

10. The method according to claim 9, wherein
the selected set of landmarks comprises at least one of eyes, eyebrows, or ears, and
the method further comprises:
detecting, by the at least one processor based on the identified features of the face of the first person, the face of the first person.

11. A system, comprising at least one processor, wherein
the at least one processor is configured to:
cause a first device to monitor a body temperature of a first person;
determine, responsive to the monitoring, as a first determination result, whether the monitored body temperature exceeds a predetermined threshold;
perform image processing on an image of the first person;
determine, based on a result of the image processing, as a second determination result, whether the first person wears a face mask; and
control a second device based on at least one of the first determination result or the second determination result.

12. The system according to claim 11, wherein the first device is a thermal scanner.

13. The system according to claim 11, wherein
the second device is a gate configured to open or close, and
in controlling the second device, the at least one processor is configured to control, based on at least one of the first determination result or the second determination result, the gate to open so that the first person can pass the gate.

14. The system according to claim 11, wherein
the second device is a speaker, and
in controlling the second device, the at least one processor is configured to control, based on at least one of the first determination result or the second determination result, the speaker to emit an alarm sound or output a voice conveying a particular message.

15. The system according to claim 11, wherein
the second device is a display, and
in controlling the second device, the at least one processor is configured to control, based on at least one of the first determination result or the second determination result, the display to display at least one of a message or an image.

16. The system according to claim 11, wherein the at least one processor is further configured to:
set a compensation temperature based on an ambient temperature; and
adjust the monitored body temperature based on the compensation temperature.

17. The system according to claim 11, wherein
the first device is one thermal scanner of a plurality of different kinds of thermal scanners, and
in monitoring the body temperature of the first person, the at least one processor is configured to:
connect one database of a plurality of databases via a server to obtain second information about the one thermal scanner; and
monitor the body temperature of the first person based on the second information.

18. The system according to claim 17, wherein the at least one processor is further configured to:
provide an application programming interface (API) that integrates the plurality of databases,
in connecting the one database of the plurality of databases via the server, the server is configured to execute the API to connect the one database.

19. The system according to claim 11, wherein
in performing the image processing on the image of the first person, the at least one processor is configured to:
select, based on a shape of a face mask, a set of landmarks from among a plurality of landmarks each representing a map of points that surround a feature of a face of a person; and
identify, based on the selected set of landmarks, a plurality of features of a face of the first person, and
in determining whether the first person wears a face mask, the at least one processor is configured to determine, based on the identified features of the face of the first person, whether the first person wears a face mask.

20. The system according to claim 19, wherein
the selected set of landmarks comprises at least one of eyes, eyebrows, or ears, and
the at least one processor is further configured to detect, based on the identified features of the face of the first person, the face of the first person.
